(19) United States
(12) Patent Application Publication
(10) Pub. No.: US 2018/0036591 A1
(43) Pub. Date: Feb. 8, 2018

(54) EVENT-BASED PRESCRIPTION OF FITNESS-RELATED ACTIVITIES

(71) Applicant: Your Trainer Inc., Austin, TX (US)

(72) Inventors: Matthew Bryant King, Austin, TX (US); Lawrence Miles Cotter, Austin, TX (US); Micah Isaac Nolte, Austin, TX (US); Frederick Drew Dodson, Austin, TX (US)

(21) Appl. No.: 15/788,108

(22) Filed: Oct. 19, 2017

Related U.S. Application Data
(63) Continuation-in-part of application No. 15/451,921, filed on Mar. 7, 2017.
(60) Provisional application No. 62/305,062, filed on Mar. 8, 2016.

(51) Int. Cl. A63B 24/00; G06F 19/00

(52) U.S. Cl. CPC A63B 24/0075; G06F 19/3481; G06F 19/3475; A63B 2024/0078

(57) ABSTRACT

Provided is a process of dynamically creating a personalized workout video for a user. The process, including: obtaining a collection of workout video blocks; retrieving a user profile attribute from a user profile, the user profile attribute including a fitness goal or exercise constraint; selecting a first workout video block from the collection based on both the fitness goal or the exercise constraint and an intensity level or body-region grouping of the selected first workout video block; sending the first workout video block to a user device of the user; receiving after beginning to sending the first workout video block; selecting a second workout video block from the collection based on the feedback, the intensity of the second workout video block, and a body-region grouping of the second video block; and beginning to send the second workout video block, with one or more processors, to the user device.

### CROSS-REFERENCE TO RELATED APPLICATIONS

The present application is a continuation-in-part of U.S. patent application Ser. No. 15/451,921, titled PROGRAMMING ENVIRONMENT FOR ADAPTIVE WORKOUT VIDEO COMPOSITION, filed 7 Mar. 2017, which claims the benefit of U.S. Provisional Patent Application 62/305,062, filed 8 Mar. 2016, titled SYSTEMS AND METHODS OF DYNAMICALLY CREATING A PERSONALIZED WORKOUT VIDEO. The entire content of each aforementioned parent patent filing is hereby incorporated by reference.

### BACKGROUND

### 1. Field

The present disclosure relates generally to computer systems and, more specifically, to systems and methods for prescribing fitness-related activities responsive to events.

### 2. Description of the Related Art

Personal trainers are generally effective in coaching and otherwise advising their clients in personal fitness because trainers are generally knowledgeable, provide instant feedback, and provide accountability, motivation, education, nutritional information, or community. However, not everybody can afford a personal trainer (as they can be expensive, typically require at least one party to travel, and impose time constraints on schedules), they are not always with their clients, and they might lack knowledge. Workout videos are used to solve some of these problems with personal trainers. However, many workout videos have static content that does not adapt to the user.

Computer systems for dynamically sequencing video content exist, such as existing “choose your own adventure” style online videos on YouTube™. But such systems are generally not well suited for technical challenges that arise in the context of dynamically sequencing video blocks for workouts. Often, workouts are sequenced by trainers based on both where the client is within a workout and real-time feedback from the client about the workout. Systems for dynamically sequencing videos are generally incapable of dynamically adapting within a larger ordered structure of something like a workout regimen.

Further, existing computer systems for dynamically sequencing videos are often slow to respond to changes warranted by user feedback and are not suitable for devices with relatively limited computing resources and network bandwidth, like many mobile devices. Many existing video delivery systems use caching techniques that lead to relatively slow responses to changes in, for example, which video segment is to be shown next. Such computer systems also often construct video segments in a way that is not tuned for compression algorithms, leading to larger files for download and slower responses. As a result, it can be difficult to repurpose those systems for more latency-sensitive use cases, such as in a workout where users wish to keep their heart rate elevated, the sequence can be difficult to predict, and users are more averse to delays between video segments while the next video segment loads to a video to a local buffer being streamed from a remote server.

Indeed, many existing systems for dynamically sequencing videos are incapable of selecting subsequent video segments based on criteria relevant to workouts. Existing systems generally provide several choices for the user, but those choices generally relate to a story arc and bear no relevance to an appropriate subsequent exercise, particularly given a user's profile and current feedback indicative of an ongoing session. Indeed, many such existing systems are not configured to account for previous sessions with a user when sequencing video segments, nor are they configured to adjust segments responsive to multi-dimensional signal sets, like attributes in a profile and current (e.g., real-time, like during an exercise) feedback.

Moreover, other computer systems for automatically constructing workouts based on user profiles (regardless of whether they target video sequences or other output formats) are lacking. Generally, such systems suffer from what is referred to in the field of computer science as the “curse of dimensionality.” In many cases, such systems map a relatively large set of inputs (e.g., age, height, weight, goals, level, muscle focus, activities, and scheduling data, like minutes per day, days per week, and number of weeks for exercising) to a set of exercises in a sequence of a workout (also selected from a large set of exercises and workout attributes).

The configuration space for these existing workout algorithms is, thus, generally very large due to the relatively large number of ways those inputs can be combined and the relatively large number of ways workouts can be constructed from a relatively large number of exercises, duty cycles, and frequencies. In short, there are nearly an innumerable amount of ways to configure an algorithm to accept these types of inputs and produce an output workout, but those different configurations vary enormously in the quality of their outputs. As a result, many existing computer systems for constructing workout sequences are configured to operate in fixed sub-optimal regions of that configuration space, relying for instance on hard coded rules that do not adapt, or on relatively limited adaptability, and that do not account for needs of outliers in diverse populations of users.

Human trainers generally navigate this configuration space for constructing workouts, with varying degrees of success, with heuristics and intuition. Computers, however, are often not well suited for addressing these types of problems that traditionally require human intuition and judgment. Computers tend to be traditionally deployed in scenarios where there is a clear mapping between inputs and outputs with well-defined and readily discerned rules.

These problems are exacerbated when attempting to provide even-more responsive, context-dependent prescriptions of a broader universe of fitness-related activities, beyond just workout videos. Workout videos are often less-fully integrated with the user's life, and as a result often less effective, than more comprehensive suites of services offered by trainers. Often trainers will prescribe provide context-dependent fitness-activities, e.g., encouraging the user to sign-up for a fitness class, encouraging the user before engaging in exercise, teaching the user about nutritional needs relevant to their current fitness activities, recommending exercises/classes/facilities based on where the user is traveling, holding the user accountable for completing fitness-related activities, celebrating with the user after completing fitness-related activities, and connecting the user to other users in a community of users engaged in related activities or pursuing similar fitness goals. The added dimensions of output and input dramatically expand the search space for optimal prescriptions of fitness related activities responsive to changes in the user's state.

### SUMMARY

The following is a non-exhaustive listing of some aspects of the present techniques. These and other aspects are described in the following disclosure.

Some aspects include a process to prescribe fitness-related activities responsive to events, the process including: receiving, with one or more processors, with a fitness prescription engine, an event indicative of a current or future state of a user, wherein: the user is associated with a mobile computing device upon which a native application executes; the native application is configured to send events to the fitness prescription engine via a network; and the fitness prescription engine is configured to prescribe fitness-related activities responsive to events for a user-base with a plurality of users including the user; determining, with one or more processors, with the fitness prescription engine, a fitness need of the user based on a user profile of the user, wherein: the fitness need is determined based on a fitness goal of the user in the user profile; and the fitness need is determined based on a previous fitness-related prescription in the user profile; determining, with one or more processors, with the fitness prescription engine, a current fitness-related prescription in response to both the fitness need and the event, wherein: determining the current fitness-related prescription comprises selecting a fitness resource from among a plurality of candidate fitness resources; and the selected fitness resource is designated in the current prescription as a fitness resource to be accessed by the user in accordance with the current prescription; and causing, with one or more processors, with the fitness prescription engine, the current fitness-related prescription to be presented to the user.

Some aspects include a tangible, non-transitory, machine-readable medium storing instructions that, when executed by a data processing apparatus, cause the data processing apparatus to perform operations including the above-mentioned process.

Some aspects include a system, one or more sensors, one or more processors and memory storing instructions that, when executed by the processors, cause the processors to effectuate operations of the above-mentioned process.

### BRIEF DESCRIPTION OF THE DRAWINGS

The above-mentioned aspects, and other aspects of the present techniques, will be better understood when the present application is read in view of the following figures in which like numbers indicate similar or identical elements:

FIG. 1 is a block diagram that illustrates an example of a computing environment configured to dynamically create a personalized workout video for a user consistent with some of the present techniques;

FIG. 2 is a tree-diagram that illustrates an example of a data structure encoding hierarchical video block groupings, in accordance with one or more embodiments;

FIG. 3 illustrates an example of a video block data structure describing attributes of a given video block, in accordance with some embodiments;

FIG. 4 illustrates an example of a user feedback data structure, in accordance with some embodiments;

FIG. 5 illustrates an example of a user profile data structure, in accordance with one or more embodiments;

FIGS. 6-7 illustrate examples of video selection pseudo code routines based on scored attributes, in accordance with some embodiments;

FIG. 8 illustrates an example state diagram for sequencing video segments, in accordance with one or more embodiments;

FIG. 9 is a flow chart that illustrates a method for dynamically creating a personalized workout video for a user in accordance with one or more embodiments;

FIG. 10 is a block diagram that illustrates another example of a computing environment that is configured to prescribe fitness-related activities (such as the personalized workout videos or other activities) responsive to events consistent with some of the present techniques; and

FIG. 11 is a flow chart that illustrates a process for prescribing fitness-related activities responsive to events in accordance with some embodiments of the present techniques; and

FIG. 12 is a block diagram of an example of a computer system by which the above techniques may be implemented.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

To mitigate the problems described herein, the applicants had to both invent solutions and, in some cases just as importantly, recognize problems overlooked (or not yet foreseen) by others in the fields kinesiology and machine learning. Indeed, applicants wish to emphasize the difficulty of recognizing those problems that are nascent and will become much more apparent in the future should trends in the dynamic-exercise-content industry continue as applicants expect. Further, because multiple problems are addressed, it should be understood that some embodiments are problem-specific, and not all embodiments address every problem with traditional systems described herein or provide every benefit described herein. That said, improvements that solve various permutations of these problems are described below.

Some embodiments mitigate some (and in some cases all) of the above-described issues with a system referred to as a “prescription engine” that, in some embodiments, guides a user through their fitness journey by leveraging resources, both physical and digital, for prescription at any given moment to advance them towards their health goals. It does this by responding to specific events (such as triggers) to activate prescriptions based on a user's profile and needs. Some implementations tell a user exactly what to do, how to do it, where to do it, and why they should be doing it at any second throughout the day when the prescription engine or determines such guidance relevant. As explained below, events activate prescriptions based on the target user's profile and needs.

Further, in some embodiments, the prescription engine implements a feedback loop, where the action a user takes on any given prescription acts as input data to further influence future decision making by the prescription engine. By taking a machine learning approach, some embodiments improve the accuracy of prescriptions over time.

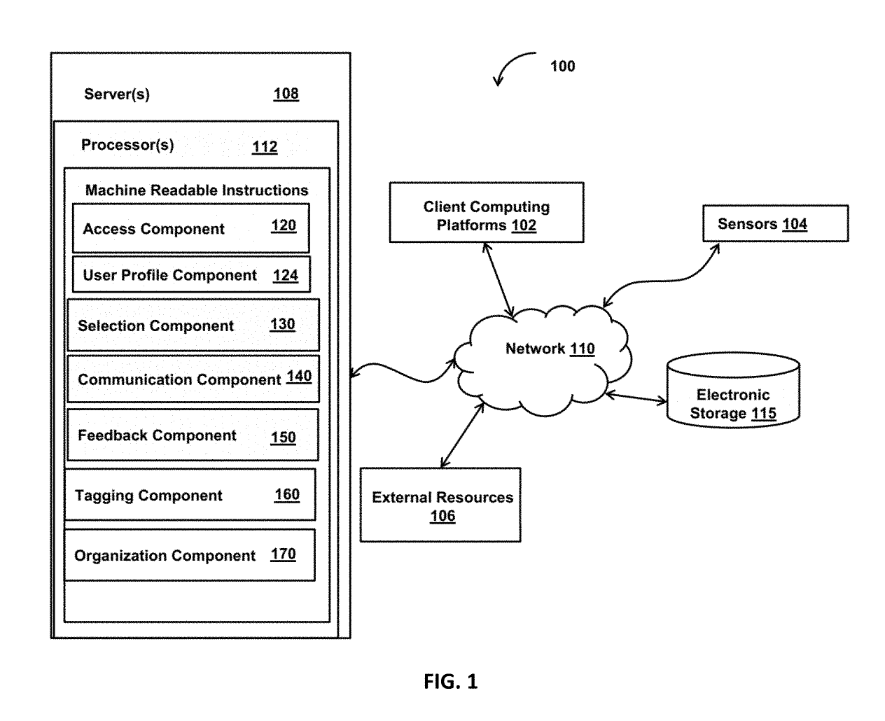

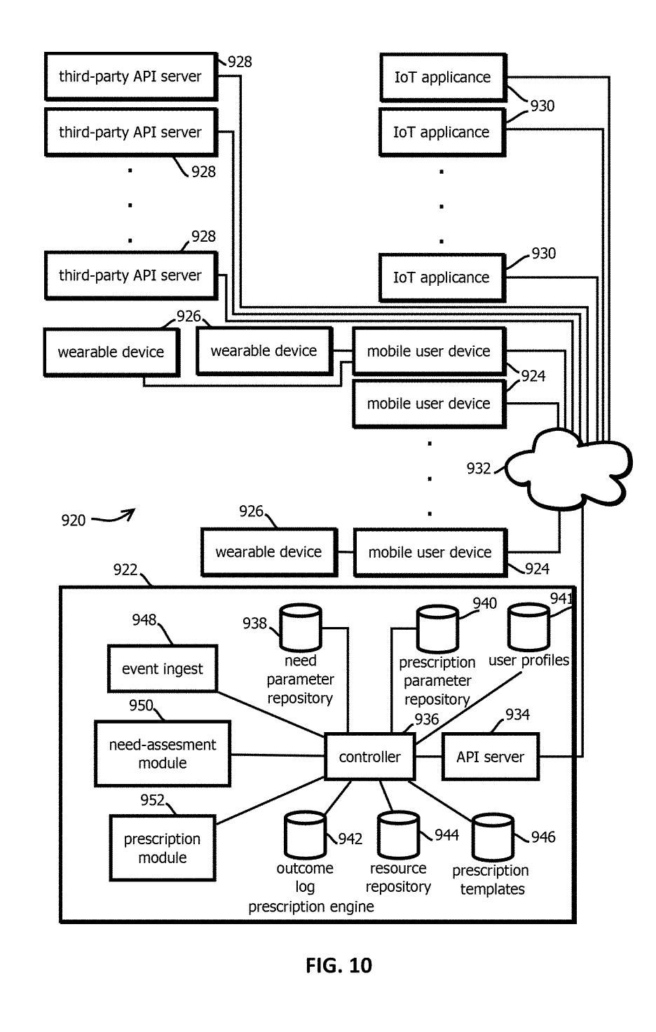

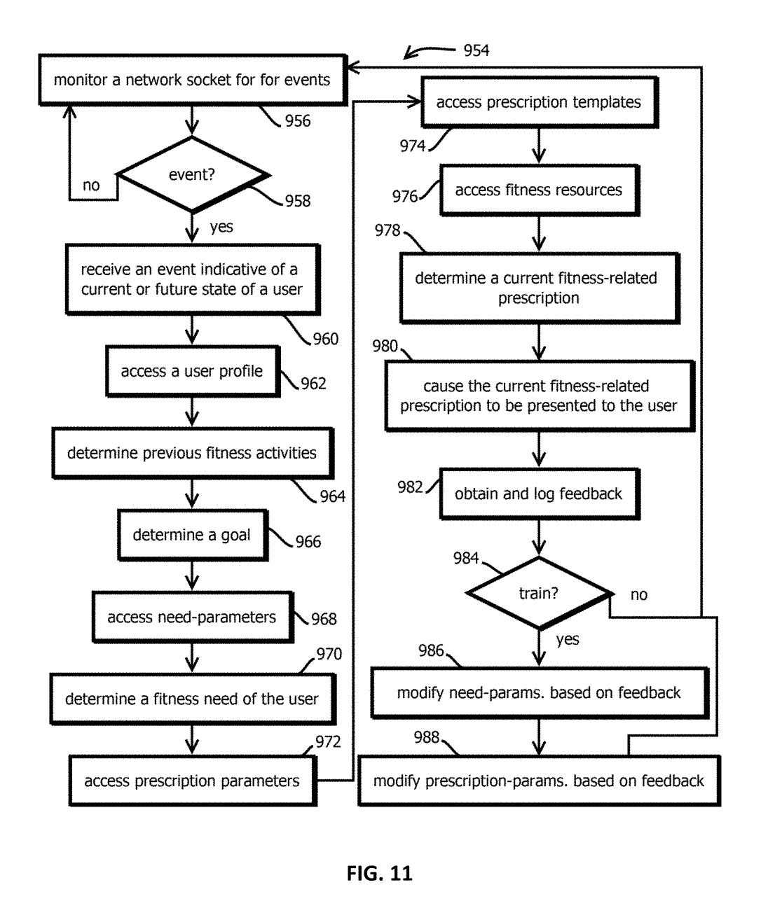

To these and other ends, some embodiments may generalize certain functionality described in the parent application (to which priority is claimed above) with respect to customized workout videos into more-challenging, higher-dimensional and more responsive and context-dependent use cases. Accordingly, the more specific use case in relation to workout videos from the parent application is described first, followed by a description of the prescription engine with respect to FIGS. 10 and 11, which in some cases, may engage the functionality described with reference to FIGS. 1-9 for certain types of prescribed fitness activities, but which is not limited to those activities, which is not to imply that any other description is limiting.

In some embodiments, the selection of video blocks in a sequence is based on both a workout stream, the location of the user in the workout stream, and real-time feedback. For instance, a workout stream may specify a low-intensity warmup, a high-intensity warmup, legs, chest, back, arms, cardio, legs, chest, back, arms, cardio, legs, chest, back, arms, cardio, and a low-intensity cool down. Within each of these stages, each of which may correspond to a selection for a video block, some embodiments may select a video block consistent with the stage based on real-time feedback. For instance, after arms, the user may indicate they are overly tired via a native application, or a heart-rate monitor may indicate a heart rate above a threshold. In response, for the next stage, cardio, some embodiments may select a lower level of intensity than would have otherwise been choses, dynamically selecting a video block while staying within the confines of the stream to have a consistent workout sequence that is tailored to their experience. Variants are described below in which a gradient descent is used to train a model for selecting subsequent video blocks, workouts, or workout plans based on things like user preferences, injuries, and patterns in previous user feedback, and the like. Further, some embodiments may achieve this with a server architecture designed to serve a relatively large number of users bandwidth intensive video feeds.

In some embodiments, some of the present techniques may provide for something akin to a domain-specific programming language for personal trainers that strikes an appropriate balance between adaptability and expert guidance. Simply conveying a list of exercises to a user, even a list selected specifically for the user, in some cases, may not provide some of the value that personal trainers provide, for example, by adapting a workout during the course of a workout or based on the user's changing goals. On the other hand, simply providing a large set of exercises for users to select among with total discretion may deprive users of some of the guidance that personal trainers provide in terms of selecting the appropriate sequences of workouts having the appropriate attributes to achieve the user's goals. As discussed above, the design space for workouts and plans of workouts is relatively large, with nearly an infinite number of ways a workout plan and respective workouts could be configured. Some embodiments provide a relatively concise way to chart adaptive paths through this design space. To these ends and others, some embodiments leverage data structures that organize content pertaining to exercises in a way that maps to these adaptive paths through parameter spaces and supports relatively expressive and dynamic workout configurations.

In some embodiments, workouts may be organized in plans, for example plans selected according to the user's goals with techniques described below. In some embodiments, plans may be arranged according to template plans in which each template plan includes a plurality of workout-selection criteria at each stage of the plan. In some cases, the criteria may specify parameters by which a plurality of candidate workouts are selected, such as workout templates described herein, at each stage, and some embodiments may select among those candidates based on various criteria, such as the user's overall goal, a user's expressed preference for a particular area of focus, or feedback from the user, for example indicating that an injury has occurred or that goals have changed. Examples of a workout focus include full body toning, tone down, endurance, strength, core, and recovery. In some cases, each stage of a plan may have a plurality of workout templates corresponding to each of these different focuses, and some embodiments may select among these different focuses to select among the candidates based on a variety of criteria, including how frequently other focuses were selected or a user expressed preference.

In some embodiments, plans may be adjusted with different candidate workouts using techniques described below by which workouts are defined and adjusted. Thus, in some cases, both plans and workouts may be partially, but not fully, defined in the sense that each may specify a sequence of candidates among which choices are made based on personalization according to evolving user profiles. In some embodiments, the different stages along these respective sequences, for example, workouts and plans or exercises in workouts, may be conceptualized as nodes in a graph. For example, each workout may correspond to a graph of candidate exercises, and some embodiments may select a path through the graph corresponding to the workout provided to a user, with selections being made at different stages based on feedback or user profile information. Similarly, workouts may be represented as nodes in a plan graph, and some embodiments may configure a plan by selecting workouts at various stages along the graph to chart a path through the graph of candidate workouts corresponding to the plan. In some cases, different types of plans, for example, corresponding to different user goals may have different graphs through which paths are chosen, in some cases with overlapping graphs.

FIG. 1 illustrates an example of computing environment 100 environment having servers 108 configured to dynamically create a personalized workout videos for a user (e.g., such that the sequence of videos defining the workout changes as a result of information obtained during the workout). In some embodiments, as shown in this example, computing environment 100 may include one or more of client computing platforms 102, one or more sensors 104, one or more external resources 106, one or more personalized workout video creation servers 108, one or more electronic storage 115, or other components, all being communicatively coupled via a network 110.

The network 110 may include the Internet or other networks, such as local area networks, cellular networks, Intranets, near field communication, frequency (RF) link, Bluetooth™, Wi-Fi™, or any types of wired or wireless networks. Such examples are not intended to be limiting, and the scope of this disclosure includes embodiments in which the client computing platforms 102, the one or more sensors 104, the one or more external resources 106, the one or more personalized workout video creation servers 108, and the one or more electronic storage 115 are operatively linked via some other communication media, which is not to suggest that other enumerated examples are limiting.

The client computing platforms 102 may include one or more processors configured by machine-readable instructions to execute computer program components. The computer program components may be configured to enable one or more users associated with the client computing platforms 102 to interface with computing environment 100, external resources 106, sensors 104, electronic storage 115, or personalized workout video creation servers 108, or provide other functionality attributed herein to client computing platforms 102. Client computing platforms 102 may be desktop computers, laptop computers, handheld computers, netbooks, tablets, smartphones, smartwatches, personal digital assistants (PDAs), cellular telephones, personal computers (PCs), or other computing platforms. Client computing platforms 102 are also referred to as client computing devices herein.

Client computing platforms 102 may include one or more physical interfaces. A physical interface included in client computing platforms 102 may be configured to provide an interface between personalized workout video creation servers 108 (or other components of computing environment 100) and a user of client computing platforms 102 through which the user may provide information to or receive information from personalized workout video creation servers 108 (or other components of computing environment 100). This facilitates data, videos, results, reports, recommendations, or instructions and other communicable items, collectively and individually examples of “information,” being communicated between the user and personalized workout video creation servers 108 (or other components of computing environment 100).

Examples of interface devices suitable for inclusion in a physical interface of the client computing platforms 102 include one or more of a keypad, buttons, switches, a keyboard, knobs, levers, a display screen, a track pad, a touch screen (e.g., a force-sensitive touch screen), speakers, a microphone, an indicator light, an audible alarm, a printer, or other interfaces through which the user may provide or receive information. It is to be understood that other communication techniques, either hardwired or wireless, are also contemplated as a physical interface of the client computing platforms 102. As such, a variety of techniques for communicating information with personalized workout video creation servers 108 or other components of the computing environment 100 are contemplated by the present disclosure as a physical interface of client computing platforms 102. In some cases, the physical interface includes a camera, a microphone, or a three-dimensional scanner (such as a time-of-flight sensor or a stereoscopic sensor configured to measure depth in a field of view).

One client computing platform is illustrated, but embodiments are configured to support substantially more, e.g., more than 100 concurrent sessions, and in many cases, more than 1,000, or more than 10,000 concurrent sessions. At such scales, particularly for bandwidth-intensive tasks like serving video where it is difficult to predict user feedback and the next video to be chosen, some of the techniques described below for serving video dynamically, with low latency between segments, are expected to be particularly important to a high-quality user experience (though embodiments are not limited to systems affording these benefits, which is not to imply that other descriptions are limiting). To this end, some embodiments may cache video on client devices, e.g., in a buffer, in the event that video fees are interrupted and prior to transitioning from one video to the next. Further, some embodiments may cache alternate video segments on a client device (e.g., an initial threshold duration of time) and select between those segments, showing one but not the other, based on real-time selections and user feedback to provide low-latency transitions between videos robust to network interruptions.

Many computer systems are not well suited to serve high-bandwidth content to a relatively large number of users concurrently, with low latency between video segments that are selected based on real-time feedback. To address these issues, some embodiments may use a web server configured to favor relatively high concurrency and relative low memory usage, e.g., Nginx. To facilitate high concurrency, some embodiments may include an asynchronous, non-blocking, event-driven server for handling a relatively large number of concurrent connections to user devices. In response to a connection or a request within a connection exceeding a threshold, some embodiments may launch a new instance of a worker processes. In some embodiments, each work process may handle more than one thousand connections. Each worker process, in some embodiments, may execute an event loop, during each iteration of which, the process may check for and process events, like user requests or posts of information on a network socket and port. Some embodiments may separate the work performed to service request from the triaging and routing of events to place relatively slow operations, like retrieving a video block from storage, in a separate thread or process from the thread or process handling the events. The event and asynchronous activity may be connected via a deferred callback function that is invoked after a function returns a result from the asynchronous process. Thus, in some embodiments, events may be processed asynchronously, allowing work to be handled in a non-blocking manner. In some cases, each server (in the software sense) may be executed in a single-thread, handling a relatively large number of connections with the thread, and thereby reducing the memory and CPU usage at times of heavy load relative to other computer servers. That said, there are a number of distinct inventions described herein, and not all embodiments use these techniques. In some cases, a web server or application program interface server may interface between the network 110 and a plurality of computing devices, e.g., in a datacenter and a content delivery network, by which the functionality of illustrated servers 108 is implemented.

External resources 106 may include sources of information, hosts or providers of information or services outside of the personalized workout video creation servers 108, external entities participating with the computing environment 100 (e.g., cloud storage), or other resources. In some embodiments, some or all of the functionality attributed herein to external resources 106 may be provided by resources included in the computing environment 100.

The personalized workout video creation servers 108 may include electronic storage 115, one or more processors 112, or other components. A single instance of the server 108 may serve personalized workout videos to a plurality of users concurrently in some cases. In the illustrated embodiment, the machine-readable instructions are shown as component of the processors 112 to indicate that the processors execute those instructions (e.g., with different processors executing different instructions), and in some embodiments, the instructions may be stored on a different component of a computer from the processors 112, for instance, in persistent storage or dynamic memory of a computer housing the processor, the memory, and the storage. In some cases, the server 108 is a web server configured to interface with a client-side web browser or an application program interface server operative to interface with a client-side native application. Personalized workout video creation servers 108 may include communication lines, components, or ports to effect the exchange of information with a network or client computing platforms 102. Illustration of personalized workout video creation servers 108 in FIG. 1 is not intended to be limiting, which is not to imply that other descriptions herein are limiting. Personalized workout video creation servers 108 may include a plurality of hardware, software, or firmware components operating together to provide the functionality attributed herein to personalized workout video creation servers 108. For example, personalized workout video creation servers 108 may be implemented by a plurality of virtualized computing instances executing in a remote data center operating together as personalized workout video creation servers 108.

Electronic storage 115 (which also includes magnetic and optical storage, as well as in-memory storage in DRAM) may be configured to store workout video blocks, information related to users, information received from sensors 104, information received from external resources 106, or other information received from within or outside computing environment 100. Electronic storage 115 may include electronic storage media that electronically (a term which is used generally herein to also encompass information stored magnetically or optically) stores information. The electronic storage media of electronic storage 115 may include one or both of system storage that is provided integrally (i.e., substantially non-removable) with servers 108 or removable storage that is removably connectable to servers 108 via, for example, a port (e.g., a USB port, a firewire port, etc.) or a drive (e.g., a disk drive, etc.). Electronic storage 115 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), or other electronically readable storage media. The electronic storage 115 may include one or more virtual storage resources (e.g., cloud storage, a virtual private network, or other virtual storage resources). Electronic storage 115 may store software algorithms, information determined by processors 112, information received from client computing platforms 102, sensors 104, external resources 106, or other information that enables personalized workout video creation servers 108 to function as described herein.

Processors 112 may be configured to provide information-processing capabilities in personalized workout video creation servers 108. As such, processors 112 may include one or more of a digital processor, an analog processor, a digital circuit designed to process information, an analog circuit designed to process information, a state machine, or other mechanisms for electronically processing information. Although processors 112 is shown in FIG. 1 as a single entity, this is for illustrative purposes only. In some embodiments, processors 112 may include one or more processing units. The processing units may be physically located within the same device, or processors 112 may represent processing functionality of a plurality of devices operating in coordination. The processing units 112 are illustrated as distinct modules of processors 112, but this should not be read to imply that the entire set of code for each module must be loaded in registers of physical processors concurrently.

Processors 112 may be configured by machine-readable instructions to execute one or more computer program components. The one or more computer program components may include one or more of an access component 120, a user profile component 124, a selection component 130, a communication component 140, a feedback component 150, a tagging component 160, an organization component 170, or other components.

The illustrated components are depicted as discrete functional blocks, but embodiments are not limited to systems in which the functionality described herein is organized as illustrated. The functionality provided by each of the components may be provided by software or hardware modules that are differently organized than is presently depicted. For example, such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine-readable medium.

Access component 120 may be configured to access a collection of workout video blocks. In some embodiments, a workout video block is a video containing one or more of a portion of a workout, an exercise, a yoga pose, training, a warm-up, aerobics, a dance, a routine, a drill, other types of physical activities, or any combination thereof. In some cases, a workout video block may include instructions of physical activities for the cardiovascular system, strengthening muscles, weight loss, to help enhance or maintain physical fitness or overall health and wellness. A workout video block may have a duration of about three minutes, or in some cases, an integral multiple of some quanta, like 1 minute, to facilitate dynamic composition. In some cases, a workout video block may have a duration of less than three minutes. In some cases, a workout video block may have a duration of more than three minutes. In some embodiments, a given individual workout video block may be the smallest video segment that can be provided to a user. For example, an individual workout video block may include one exercise.

In some cases, each video block may correspond to a distinct file data structure in memory, e.g., Windows Media Video, an MPEG-4 Video, a Flash Video, or the like, separate from other video blocks. In some cases, the videos may be pre-compressed to facilitate relatively fast distribution of videos to a relatively large number of users with relatively low bandwidth. Bandwidth usage is expected to be particularly challenging for mobile device use cases on cellular networks in the absence of wireless local area networks. Users expect robust service, even when traveling in remote areas with less advanced cellular data networks. For instance, video files may be compressed with Advanced Audio Coding (AAC), and in some cases by detecting and discarding signal components that are imperceptible to a user and by identifying and grouping redundant information in video files. To facilitate the former, some embodiments may drop higher and lower audio frequencies with a band-pass audio filter, and filter video detail according to spatial frequency, removing details as needed to satisfy compression targets. To facilitate the later, in some cases, videos may be recorded against a low-information background, like a uniform white background to increase the portion of each frame that is redundant, e.g., a white pixel of uniform intensity. In some cases, more than 50% or more than 70% of each frame may be a uniform color, identical between frames, or both, for more than 50% or more than 70% of each video block. Uniform colors may reduce entropy in areas of a video and facilitate compression. That said, not all embodiments employ compression in this manner, as other inventive aspects are described.

Each individual workout video block may include an exercise that is different from the exercises in other workout video blocks, or may include the same exercise (or a variant of the same exercise) as in other workout video blocks but at different levels of difficulty (e.g., hard, medium, easy, or level 1, 2, 3, etc.). In some embodiments, video block may have video segments, such as every minute or with bookmarked timestamps within the video, and some embodiments may dynamically terminate videos at the end of those segments, applying less than a full video block to adapt to user feedback more quickly rather than waiting for the entire video. Or some embodiments may adapt at the end of one video or upon receiving feedback.

A separate data structure may provide relatively rich labeling of attributes of the videos, and that labeling may be used to select among the videos when dynamically sequencing blocks in a workout. In some embodiments, the exercise included in an individual workout video block may target one or more of a specific body-region (e.g., lower body, upper body, core, arms, etc.), may target a specific fitness goal, a specific physiological function (e.g., breathing, etc.), or other targets. A data structure, described below, may associate each video block with these parameters, and that data structure may be interrogated to dynamically select and sequence videos in accordance with the general parameters of a workout routine specified by another data structure and real-time user feedback, in some cases.

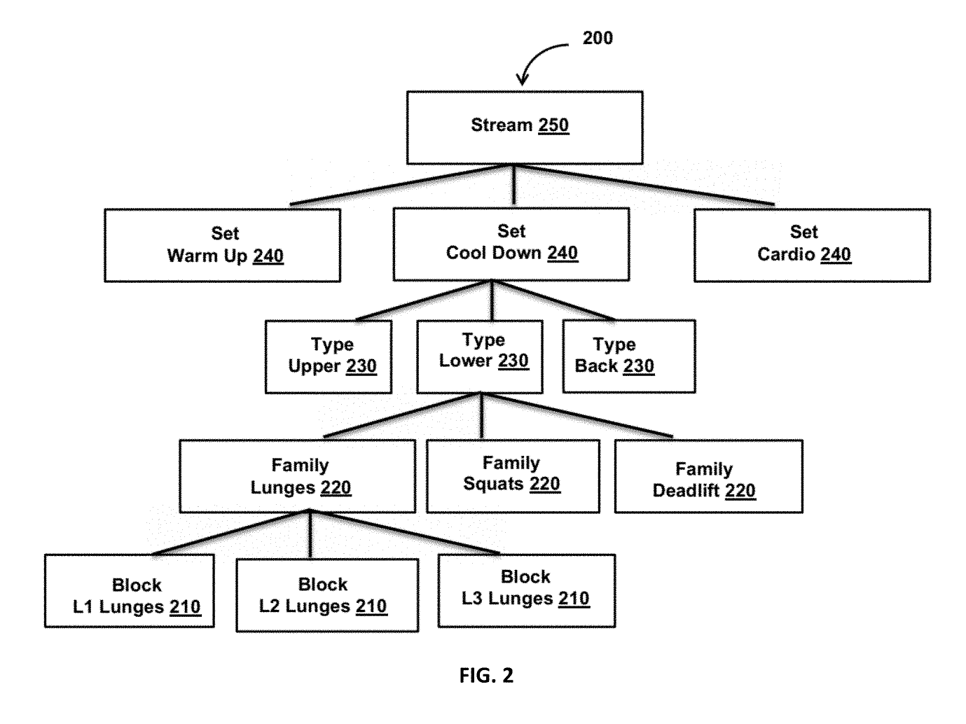

In some embodiments, the collection of workout video blocks may include a plurality of groupings of the workout video blocks (e.g., the groupings may be by body-region, by fitness goal, by physiological function, or other groupings.) Groupings may be expressed by associating a unique identifier of each video block file with a value corresponding to the grouping, e.g., a tag for “upper body” or “legs.” Video blocks may be associated with multiple tags to facilitate intelligent sequencing of videos according to multiple dimensions, in some embodiments. In some cases, a hierarchical taxonomy of video blocks is provided, e.g., designating a block as “upper_body,” “pectorals,” “low_intensity_pectorals.” Attributes may also include an intensity level. In some embodiments, a body-region grouping (e.g., lower body, upper body, core, arms, etc.) may include a plurality of workout video blocks designated as having different workout intensity (e.g., hard, medium, easy, or level 1, 2, 3, etc.). FIG. 2 illustrates an example 200 of different video block groupings in accordance with one or more embodiments. Workout video blocks 210 may be grouped into families 220. A family 220 may include blocks 210 that are related to each other in some way (e.g., the same exercise with varying intensity). In some cases, a family 220 may include three, five, ten, or more blocks 210, each block containing a variation of one exercise (e.g., along a single dimension, like intensity, or along two or more dimensions, like intensity and range of movement). The blocks in the family may be ordered such that the first block in the family (in this case, the first block may be referred to as Level 1) is the easiest version of the exercise, and the last block in the order is the hardest version of the exercise. A user with low physical fitness may find Level 1 appropriate, where someone of high physical fitness would find a higher level more appropriate.

Families 220 may be grouped together within the video-block metadata data structure by block type. For example, as shown in FIG. 2, a block type group 230 may be a body-region. In some cases, a block type group may include families where the blocks contain exercises that target a specific body-region (e.g., lower body, upper body, core muscles, legs, arms, back, etc.). For example, a “Lower” group may contain a family of squats and a family of lunges.

In some embodiments, the block type groups may be grouped into sets. For example, as shown in FIG. 2, a set 240 may include one or more block type groups 230 each block type group 230 representing a different body region (e.g., a “Warm Up” set may include a “lower”, “upper”, “back” block type groups).

In some cases, a group of sets 240 may be referred to as a stream 250, where a stream is made of sets among which selections are made to compose video blocks for a complete workout. The user may choose to play a stream from start to finish. The user may choose the length of the stream. For example a full body stream may include warm-up (1), warm-up(2), warm-up(3), lower, then upper, cardio, full, core, cardio, cooldown 1, and cooldown 2. Other examples of stream include tone down stream, endurance stream, strength stream, core stream, recovery stream, or other streams.

Or in some embodiments, the upper portion of FIG. 2, the stream 250 and the sets 240, may be encoded in a first data structure, e.g., one at least partially defining a sequence of a workout, while the lower portion (types 230, families 220, and blocks 210) may be defined in a second different data structure that organizes atomic units by which the first data structure partially or entirely defines a workout by referencing the second data structure.

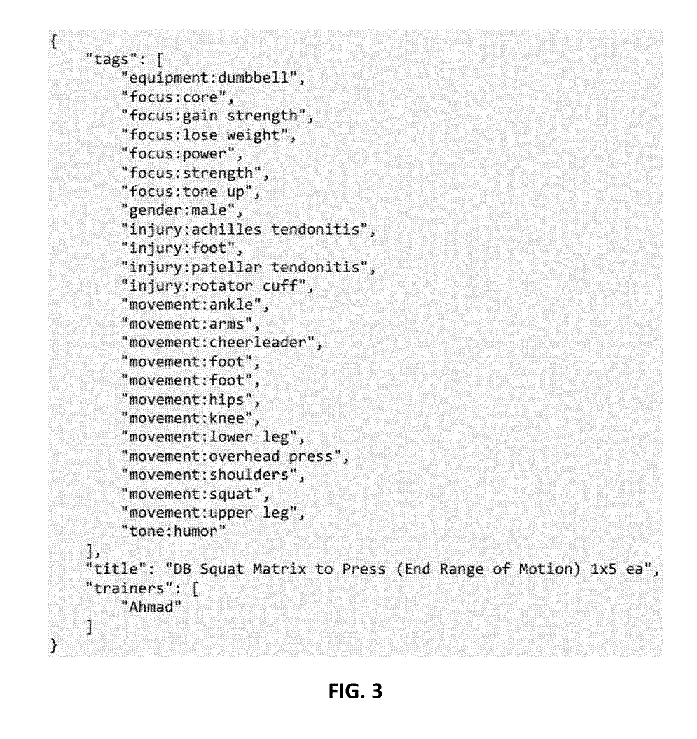

Three blocks, three families, and three types are shown, but commercially relevant embodiments are expected to include substantially more of each, with substantially more families in each type, and substantially more blocks in each family. In some cases, the blocks may be arranged in a multi-dimensional matrix, with a pointer to a given video block file at each value of the matrix. Dimensions of the matrix may correspond to attributes of the video blocks, e.g., a muscle, a muscle group, an intensity, a range of movement, and the like. A data structure need not be referred to as a matrix in program code to serve as a matrix, provided that the data structure associates each video block with a plurality of attributes that can correspond to dimensions of a matrix. In some cases, the dimensions may include those listed in FIG. 3.

In some embodiments, the dimensions of the matrix and other attributes of video blocks may define a parameter space, with each dimension of the matrix (or video block (or corresponding exercise) attribute) corresponding to a dimension in the parameter space. In some cases, the dimensions may be nominal, for example, identifying body parts engaged in videos located at positions along those dimensions corresponding to the body parts, or in some cases, the dimensions may be ordinal, for example indicating easier or more difficult versions of a given exercise, with a given instructor. Other examples of nominal dimensions include identities of instructors, gender of instructors, instances of workout equipment used in the respective videos, and the like.

As shown in FIG. 1, in some cases, the workout video blocks may be located in electronic storage 115. In some cases, the workout video blocks may be stored in a workout video block repository located in one or more locations within, or outside of computing environment 100 (e.g., websites, web platforms, servers, storage mediums, cloud storage, etc.). In some cases, video blocks may be stored in a content delivery network to facilitate relatively fast access to the videos from geographically closer repositories. Some embodiments may send client computing devices instructions to retrieve designated blocks from such content delivery networks. Or some embodiments may cache video blocks on user devices for peer-to-peer video distribution, e.g., with a bit-torrent implementation addressing video blocks with a distributed hash table. In some cases, copies of the video blocks may be replicated in different service regions of a cloud data center provider, and some embodiments may serve videos to client computing devices from the different regions based on geographic proximity, demand, or available capacity. Some embodiments may include a reverse proxy server between the client computing devices and the servers 108 operative to receive network requests to a given Internet Protocol address, for instance from anywhere in the world, and route that request to an instance of one of the servers 108, e.g., in a selected geographic region. In some cases, the reverse proxy server may maintain in memory a network-address translation table that maps a session identifier associated with network communications in a given session with a given computing device to a proxied address, such that the reverse proxy may route communications consistently to the same instance of the server 108 over time for a given client computing device. Or some embodiments may wrap received network packets with a protocol wrapper packet, like a TCPwrapper, with the wrapping packet having a header identifying the server address as a recipient and the wrapped TCP packet in the payload of the TCPwrapper packet having the reverse proxy server's address in the recipient field of the header. In some cases, TCP connections between the reverse proxy server and the servers 108 may be a persistent TCP connection to expedite delivery video over the duration of the connection and reduce delays due to establishing new connections.

Video blocks may be formed by having a workout instructor come to a studio to record video and audio of every permutation of the exercise groups and families. Often users prefer to have workouts sequenced from the same instructor all the way through, and a comprehensive video block set may provide for this feature. That said, some embodiments may compose workouts video streams from blocks of different instructors too. Access component 120 may be configured to perform one or more of its functionalities in response to requests from users, components within or outside computing environment 100, or other requests. Access component 120 may be located within personalized workout video creation servers 108, within client computing platforms 102, sensors 104, or locations within or outside computing environment 100.

In some embodiments, a workout video block may include instructions provided by a human instructor (e.g., a coach, a trainer, a physical therapist, a chiropractor, a healthcare provider, or other person giving the workout instructions). In some cases, the instructions may be described or demonstrated by the person giving the instructions in the video, described by a person different than the persons demonstrating the workout instructions, or any combination thereof. In some embodiments, a workout video block may include instructions provided by a machine generated character configured to describe or demonstrate workout instructions (e.g., an avatar). In some embodiments, the user may choose an avatar from a list of avatars (e.g., avatar that looks like the user or an avatar that looks like a celebrity, etc.). In some embodiments, the user may upload an image (of themselves of someone else to be used in the creation of the avatar). In some cases, a workout video block may include a combination of instructions provided (described or demonstrated) by a human and a machine generated character. For example, a video may show a real person describing the workout and an avatar performing the workout. In some embodiments, workout video blocks in the same group (e.g., family, block type, set, stream, or other groups) may be provided by the same instructor (human, or machine generated). For example, a user may choose any particular instructor for any workout video block (every instructor provides instructions for all the workout sessions available to the user). In some cases, specific instructors (human, or machine generated) may provide specific workout instructions. For example, some instructors may only give instructions for specific body-regions (e.g., legs, arms, etc.), for specific level of difficulty, for specific workout type (e.g., warm-up, cool down, cardio, etc.), or other specific workout instructions.

In some embodiments, user profile component 124 may be configured to obtain one or more user profiles or user other information associated with users of computing environment 100. The one or more user profiles or user information may include information located in one or more of the client computing platforms 102, external resources 106, sensors 104, storage 115, or other locations within or outside computing environment 100 (e.g., websites, web platforms, servers, storage mediums, cloud storage, etc.). The user profiles may include one or more of user profile attributes, for example, information identifying users (e.g., a username, a number, an identifier, or other identifying information), security login information (e.g., a login code or password), account information, subscription information, health information, medical information (e.g., medical history, medications, etc.), physiological information (e.g., height, weight, age, gender, etc.), fitness information (e.g., fitness level, fitness achievements, etc.), restrictions (e.g., exercise constraint), fitness goals, physiological information, relationship information (e.g., information related to relationships between users in the computing environment 100), usage information, demographic information, history, client computing platforms associated with a user, or other information related to users. In some embodiments, user profile component 124 may be configured to access websites, web platforms, servers, storage mediums, or other locations from where user profiles may be accessed, obtained, retrieved, or requested in response to requests from users, components within or outside computing environment 100, or other requests. For instance, third-party API's for fitness trackers, networked scales, or networked fitness equipment may be accessed to retrieve metrics by which the profiles are enhanced. Profiles may include user feedback on particular exercises and instructors, as well as user constraints, like indications that certain body areas are susceptible or subject to injury. These values may be referenced when composing automatically workouts, e.g., embodiments may match an injured body area to a body area of workout videos and in response select corresponding, e.g., lower, level of intensity of video block.

In some embodiments, the user profile may include information related to the user's fitness. In some cases, fitness of the user may include one or more of physical, mental, social or emotional health or fitness. In some embodiments, fitness of the user may be a measure of the user's ability to perform a task, the user's ability to function efficiently and effectively in work or leisure activities, or a measure of other physical attributes (e.g., strength, endurance, power, speed, balance, coordination, etc.). In some embodiments, the user profile may indicate the level of fitness of the user (e.g., fit, not fit, etc.). The user profile may indicate the user's personal performance (e.g., marathon time, sprint time, swimming time, weight lift ability, or other personal performance). In some embodiments, the user profile may indicate physical constraints. For example, the user profile may include injuries, exercise constraints, health care professional recommendations regarding specific physical activities (e.g., based on the user's health), or other constraints that the user may have. In some embodiments, the user profile may include information related to a fitness goal of the user. For example, improving a specific function, skill, or a physical attribute. In some cases, a fitness goal may indicate a general goal (e.g., improve physical, mental, emotional fitness, etc.). In some cases, a time frame may be associated with the fitness goal (e.g., I want to complete a marathon in six months). The time frame may be defined by the user, personalized workout video creation servers 108, or a combination thereof. In some embodiments, personalized workout video creation servers 108 may recommend one or more time frames based on the user information (e.g., fitness level, age, health condition, etc.). In some cases, the user profile may include the user preferences. For example, the user may indicate the type of workout he prefers or does not prefer (e.g., cardio, aerobic, etc.), or the type of workout to not show (do not show lunges, etc.). In some cases, the user profile may indicate a ranking of workouts based on the user's preferences, constraints, fitness goals, or other user profile attributes.

In some embodiments, user profile component 124 may be configured to obtain information related to the user from other sources of information within or outside of computing environment 100. In some cases, user profile component 124 may be configured to obtain information related to the user from sensors 104. Sensors 104 may be configured to transmit (e.g., wired or wirelessly) information directly to access component 120, user profile component 124, personalized workout video creation servers 108, or other components within or outside computing environment 100, or sensors may communicate with a third-party server to which the system has access. In some embodiments, information may be transmitted to personalized workout video creation servers 108 from a remotely located database that is part of external resources 106, for example. In some embodiments, personalized workout video creation servers 108 may obtain sensor information from a database storing sensor information, or other resources by electronically querying or requesting information from such devices and receiving the information in response. It should be noted that these examples, or any others herein, are not intended to be limiting.

Sensors 104 may be configured to generate output signals conveying information related to the user. In some embodiments, sensors 104 may include audiovisual sensors, activity sensors, physiological sensors, biometric sensors, or other sensors. Examples of such sensors may include a heart rate sensor, a blood pressure sensor/monitor, a weight scale, motion sensors, an optical sensor, biometric sensors, a video sensor, an audio sensor, a color sensor, a blood glucose monitor, a blood oxygen saturation monitor (e.g., a pulse oximeter), a hydration monitor, a skin/body temperature thermometer, a respiration monitor, electroencephalogram (EEG) electrodes, accelerometers, activity sensors/trackers, a GPS sensor, or other sensors. These examples should not be considered limiting. Sensors 104 are configured to generate various output signals conveying information related to the user that allows computing environment 100 to function as described herein. In some embodiments, sensors 104 may be disposed in a plurality of locations within or outside of computing environment 100. For example, sensors 104 may be on the user (e.g., wearable device), coupled with the client computing platforms 102, located in a medical device used by the user, positioned to point at the user (e.g., a video camera), or in other locations within or outside of computing environment 100. In some embodiments, information related to the user may be obtained through a combination of user input, user selection, sensor outputs, or other methods.

Information related to the user obtained from sensors 104 may include physiological information, behavior information, or other information obtained from sensors 104. Examples of physiological information may include heart rate, blood pressure, weight, pulse rate, blood chemistry, blood oxygen saturation, blood glucose level, hydration information, respiration rate, breathing information, skin/body temperature, brain activity, physical movement or lack of movement, activity duration information, physical pain information, or other physiological information. Examples of behavior information may include the user demeanor, voice, look, gestures, manners, attitude, or other behavior information. In some embodiments, user profile information may be updated based on information from sensors 104. For example, user profile information may be updated periodically, for example, user profile component 124 may be configured to periodically obtain information from sensors 104 and update the user profile information based on information from sensors 104. In some cases, the user may set the frequency of the update from the sensors. In some embodiments, the user profile information may be updated dynamically responsive to changes in information obtained from the sensors.

In some embodiments, some of the user profile information may be obtained through accessing the user profile on one or more social media sites, or the user's online presence (instead of asking the user questions, user profile component 124 may be able to extract information about the user's behavior, past activities, preferences, user's ratings of other workouts, likes and dislikes, etc.). This operation may be performed by user profile component 124, or other components within or outside of computing environment 100. User profile component 124 may be configured to collect and store data about the user obtained from one or more social media sites, or from the user's online presence (e.g., products viewed, or bought online, viewing times, rating, behavior, etc.)

Selection component 130 may be configured to select a first workout video block from the collection of video blocks. In some cases, selection of the first video block may be based on one or more of the user profile information, the user preference, information obtained from sensors 104, the groupings of the workout video blocks (e.g., body-region), workout intensity level, information obtained from other components of computing environment 100, or any combination thereof. For example, a first workout video may be selected based on one or more of the fitness goal of the user, a fitness level of the user, exercise constraints, health information, medical information, or other user profile attributes (described above). Examples may include: a low intensity upper body workout may be selected for a user whose profile indicates that the user wants to strengthen his upper body and that indicates that the user does not like to run; or a restorative exercise may be selected for a user whose profile indicates some type of injury or recent medical procedure; a high intensity, fast paced workout may be selected for a user whose profile indicates a high degree of fitness; etc.

In some embodiments, the first workout video block may be selected based on reviews, recommendations, or feedback from the user or other users. In some cases, a review associated with the workout video blocks refers to a review or a feedback provided by other users of the computing environment 100 describing their experience as users with computing environment 100, or their feedback about the workout video blocks. In some embodiments, a review of the workout video blocks may include comments about effectiveness of the workout in achieving specific goals, quality of the video blocks, comparison with other workout video blocks or other information related to the workout video blocks. For example, access component 120 may be configured to access one or more databases (e.g., a workout video reviews database) storing one or more reviews associated with the workout video blocks via network 110 for example. The workout video review database may be located within or outside of computing environment 100. In some cases, sources for user reviews may include reviews from e-commerce sites (e.g., app stores, etc.), social media sites (e.g., Facebook™, Twitter™, etc.), blogs, online review websites, web pages, emails, documents, PDFs, scanned text, or other sources containing reviews related to the workout video blocks. In some embodiments, reviews associated with the workout video blocks may include ratings of the workout video blocks (e.g., star ratings, thumps up or down, likes, dislikes, etc.).

In some embodiment, selection component 130 may be configured to analyze information obtained from one or more of the user profile, from sensors 104, from the reviews database, or other information, and select the first workout video block from the collection of video blocks based on the analysis. In some cases, analysis of the information obtained may include comparison of the content of the reviews with information from the user profile, or the sensors information. For example, selection component 130 may select a workout video block that is highly ranked among one or more users belonging to the same demographic as the user (users with a rating history similar to that of the user, same age, gender, physical attributes, etc.). In some embodiments, selection component 130 may select a workout video block that is highly ranked among one or more users having similar fitness goals, similar exercise constraint, or other similarities with the user.

In some embodiments, selection component 130 may be configured to select a first video block based on the location of the user obtained from a locator (e.g., GPS). In some embodiments, the locator may be included in sensors 104, client computing platforms 102, or other components within or outside computing environment 100. For example, if the user is near a park, selection component 130 may select a workout video block that gives workout instructions that are appropriate for outdoors (e.g., a workout that includes running, sprinting, jumping, etc.). Another example, if the location of the user indicates that the user is home, selection component may select a workout that is more appropriate with indoors (e.g., a workout that does not include running, weight dropping, or jumping).

In some embodiments, workouts may be selected and dynamically configured based on equipment available to the user. In some cases, a user may indicate which equipment is available, for example, in their home, and some embodiments may select workout videos having as parameters of those video blocks an indication that the identified equipment is used in the video block. In some cases, each of the video block may indicate required equipment, optional equipment and the like (e.g., in the data structure of FIG. 3), and some embodiments may construct workout videos, for example, dynamically in view of (e.g., consistent with constraints imposed by) equipment available to the user.

In some embodiments, the presently described distributed application (executing on client computing devices 102 and the servers 108) may be integrated with various workout facilities, such as gyms, yoga studios, exercise bike studios, and the like. In some embodiments, the servers 108 may maintain in memory records describing various workout facilities, for example, with the record indicating a geolocation of the workout facility (e.g., a bounding polygon, grid rectangle, or centerpoint and radius), and an inventory of equipment for workouts present at the gym, for instance, a number of bench presses, a number of stair machines, a number of lat-pulldown bars, and the like. In some embodiments, these records may also indicate locations of the equipment within the respective facility. In some embodiments, each instance of each piece of equipment may be associated with the related equipment-instance record indicating its location in the facility, attributes (name, range of resistance supported, targeted body parts, etc.) and usage statistics. Examples of usage statistics may include a probability based on historical patterns that a given piece of equipment is in use at a given time of day, on a given day of the week, and during a given month of the year, for example. In some cases, usage statistics may also indicate statistics of frequency of use and duty cycle of use, for instance, indicating that an average user uses a given piece of equipment for on average three minutes with the standard deviation of 30 seconds on Mondays between 1 PM and 3 PM in the month of December.

In some embodiments, workouts may be dynamically composed (for example, by constructing sequences of workout video blocks) based on these records of workout facilities. For example, in some embodiments, the application executing on the user computing device may interface with a geolocation framework of an operating system of the user device and subscribe to events indicating that the user computing device has crossed (or is within) a geo-fence associated with the workout facility. Upon detecting traversal of the geofence, or upon watching the application determining that the device is present within the geofence, some embodiments may access one of the above-described workout facility records, for example, server-side or client-side. In some cases, the client user computing device may send an indication to the server with a unique identifier of the workout facility, for example, associated with the geofence, by which the record of the facility may be retrieved. In other cases, the user's presence may be indicated by the user selecting a facility from a menu or scanning an wireless code with their computing device (e.g., a QR code with their camera or an NFC code with an NFC sensor).

In some embodiments, a workout may specify a sequence of exercises and associated videos, some of which involve various pieces of equipment at a workout facility. For example, the user computing device may send a request for a workout indicating an identifier of the facility, some embodiments, may access a template workout for the user, for example, one constructed with the techniques described below based on the user's profile.

Some embodiments may then select workouts consistent with both a workout template and equipment available at the workout facility. In some cases, the templates may specify a sequence of criteria by which each video block is selected (e.g., body region, intensity level, muscle group, injury constraints, or the like). In some cases, the templates may also specify subsets of the sequence amenable to being re-sequenced (e.g., a first portion may identify three sets of criteria that may each be applied in any order to select three respective workout videos, followed by a second portion that identifies five such sets of criteria, and then a third portion with two sets of criteria for a total of ten workout videos). In some cases, each video that satisfies the criteria at a given stage may be referred to as a candidate video, and those candidate videos may each be associated with workout equipment. In some embodiments, an application executing on the user computing device may include an input by which the user can indicate that a given piece of workout equipment is busy, and some embodiments may dynamically recompose the workout by accessing the above-data structures, for instance, by advancing to a next workout video block in portion that the template indicates can be resequenced (e.g., selecting a different of the five in the second portion above), or by choosing alternative workout video block among the candidates that satisfy the set of criteria and, thus, are consistent with the user's goals and the workout template.

For example, a workout template may indicate that the user is to exercise biceps next, and the system may identify two video blocks that satisfy the criteria, e.g., one depicting use of a bicep machine, and one depicting a free-weight preacher curl exercise. The system may select a video block for the user to exercise biceps on the bicep machine and instruct the user to move to the machine. Upon arriving, the user may indicate that the bicep machine is busy (e.g., a user interface may present the user two inputs between exercises by which they indicate when they have arrived and if the next station is busy). Some embodiments may then cancel that video block and queue up another video block for a preacher curl by choosing an alternate consistent with the criteria of the template. In another example, the biceps exercise may be part of a portion of a workout template that specifies biceps and triceps can be done in any order, and some embodiments may instead choose a triceps exercise and defer the bicep exercise.

In some embodiments, the criteria sets are search criteria or in some embodiments the criteria sets are filter criteria. Filter criteria may return responses that satisfy the criteria, without necessarily indicating an amount of responsiveness. Search criteria may return results that indicate a strength of correspondence between the criteria and the result. For example, a criteria set may specify five different criterions for selecting a subsequent video block (e.g., male trainer, upper body area, high intensity, knee-injury compatible, no bench press equipment), and some embodiments may identify video blocks that satisfy at least some of those criteria, in some cases indicating how many criteria are satisfied, and some cases with a weighted sum of Boolean values indicating whether each criterion is satisfied. Some embodiments, thus, may score video blocks or the exercises therein according to an amount of correspondence between search criteria and respective attributes of the video blocks. Some embodiments may rank exercises or the video blocks depicting those exercises according to these scores and select a highest or lowest ranking video block, for instance, depending upon whether the higher scores indicate higher correspondence or vice versa. In some embodiments, the scores may be weighted based on various criteria before ranking, for example, based on the last time a video block was viewed by the user, an area of the body was exercised by the user, a fitness focus was pursued, or the like. Further, in some cases, scores may be weighted based on amounts of likes or dislikes or other ratings previously submitted by the user for video blocks involving the same exercise or the same body group with the same instructor previously.

In some cases, the system may determine to re-sequence rather than change the exercise based on the usage statistics. For instance, some embodiments may compare usage statistics of exercise equipment associated with each candidate video block and select a candidate video block upon determining that the selected candidate has lower than a threshold probability of being in use. Upon determining that no candidates satisfy the threshold (e.g., are greater than, are greater than or equal to, are less than, or are less than or equal to, depending on whether the metric is inverted), some embodiments may then resequence the workout. Or some embodiments may select a next video block associated with the equipment having a highest probability of being available.

Thus, some embodiments may guide the user through a workout relatively quickly while still meeting the user's goals and accommodating relatively busy portions of workout facility. Some embodiments may predictively construct the workout sequence based on predicted usage of equipment. In some cases, a workout facility may provide an application program interface by which workout equipment may be queried to determine whether the workout equipment is in use. For instance, some facilities may provide workout equipment with sensors by which the equipment registers as being in use with a central server that exposes the data via an API. In some cases, a reported use state, rather than (or in addition to) a probability of use, may be referenced in the selectin above. In some cases, embodiments may query the API for each piece of work out equipment in each candidate video block for the remainder of a workout template. Based on a response, some embodiments may determine that equipment that is difficult to access (e.g., has lower than a threshold probability of being available) is unused and advance a workout video block consistent with the above techniques to select a next video and take advantage of the unused equipment. Or in another example, some embodiments may determine that the user is to exercise calf muscles next and, based on historical usage patterns, select a particular calf muscle exercise that uses a piece of workout equipment that has a predicted low usage rate at the current time at the workout facility.

Some embodiments may optimize a workout on a facility-wide basis, for example, on behalf of a workout facility, such that the aggregate set of workouts among users of the facilities are optimized collectively to maximize equipment usage, minimize deviations from scheduled workouts, minimize user workout time, or optimize a weighted combination of these and other factors. Some embodiments may execute a bin packing algorithm to select among candidate exercises consistent with available candidates, e.g., some embodiments may execute a first fit algorithm.

In some cases, selections may be batched for a facility periodically. Some embodiments may, for example, select for a group every minute, or according to some other frequency. During each iteration, to form a batch, some embodiments may collect a set of requests for a next exercise corresponding to a plurality of users and constraints on the next exercise for each of those users, like a list of candidate next exercises for each user for each remaining portion of a current workout that permits resequencing. Some embodiments may then optimize within that collection for the group with various bin packing algorithms, for example, a first fit algorithm, a best fit algorithm, a next fit algorithm, or the like. In some embodiments, the algorithm may implement a greedy optimization within a given batch, e.g., it may minimize an aggregate amount of wasted time among the group within a given round of selection. Some embodiments may repeat this process, for example, every 30 second, every minute, every two minutes, or according to some other frequency. Or some embodiments may greedily select a next workout for each individual based on a next piece of equipment expected to be available consistent with one of several candidate next exercises.

Communications component 140 may be configured to send the first workout video block to a user device of the user (e.g., client computing platforms 102). In some embodiments, communication component 140 may be configured to communicate via a user interface within client computing platforms 102, via email, via text messages, via a website, and or with other forms of communication. For example, in some embodiments, communication component 140 causes a user interface to display the selected workout video block. In some cases, communications component 140 may be configured to communicate other information related to the selected workout video block (e.g., description, reviews, ratings, etc.). In some cases, communications component 140 may be configured to send other information to the user. For example, the user may receive promotions, health tips, workout tips, reminders (e.g., it has been “a number of days” since your last workout), and/or other information.

Sending videos may be accomplished with a variety of techniques. In some cases, videos are sent with transmission control protocol (TCP) packets. Or in some embodiments, other formats may be used to expedite video delivery. Often, TCP packets are sent with a sequence identifier, and a network stack of an operating system of a receiving device may arrange received packets according to this sequence identifier before passing the packets to an application registered in the operating system to monitor a network socket having a port number in headers of the packets. As a result, often a delayed packet can prevent other packets from arriving, and rather than merely dropping a frame, an entire video may cease playing or buffering. To mitigate this issue, some embodiments may encode packets with a different layer four protocol, for example, one that does not require all packets be placed in sequence before packets are processed by the receiving application. In some embodiments, video packets may be sent in User Datagram Protocol packets (UDP), such as with the Quick User Datagram Protocol (QUIC). In some embodiments, dual protocols may be used for different types of information, e.g., video may be sent with UDP, and feedback and other content may be exchanged via TCP.

In some embodiments, each video block may be obtained in a relatively high-quality, high-bit rate format, and multiple copies of the video block may be encoded at varying levels of compress, with varying bit rates. Some embodiments may dynamically select among these candidate copies for a given video block based on a bandwidth of a connection with a given user computing device, e.g., based on a rate of delivery of a previous video block or sequence of frames or based on a packet loss rate for a previous video block or sequence of frames. In some cases, bitrate may be varied by down sampling spatially, in color space, in time, or by adjusting video compression algorithms to discard more information in the original copy. In some cases, different quality levels may be dynamically selected and sent during a given workout to accommodate changes in available bandwidth.

Feedback component 150 may be configured to receive feedback from the user. In some embodiments, the feedback may be received after beginning to sending the first workout video block. For example, the user may be able to provide feedback on the first workout video block (e.g., the user can accept, reject, skip, like, dislike, harder, easier, or provide other feedback) before the video is received, after the video block is received but before it's played, while the video is playing, or after playing the video. In some embodiments, the user may indicate a physical condition as feedback (e.g., tired, hurts, etc.) In some embodiments, the user may provide feedback on the first workout video based on the description of the workout video block that is being sent. The description of the workout video block may include the name of the workout, description of the workout steps, description of the type of workout, description of the benefits, and other information describing the workout. In some cases, a description of the workout video block is sent to the user before the workout video block. In some cases, the description is sent simultaneously with the workout video block.

In some embodiments, the user may be presented with choices (or questions) to help him provide feedback. The user may be presented with one or more choices that he can select to provide his feedback. For example, the user may select one or more of “accept”, “reject”, “skip”, “like”, “dislike”, “harder”, “easier”, “more like this”, “less like this”, never like this”, “thumbs up”, “thumbs down”, “a number of stars”, etc. As a result of selecting one or more action, the user may be presented with more choices, or questions to provide more specific feedback. For example, the user may be asked why he didn't like a video block, or why he liked a video block or the user may be given the choice between multiple video blocks to get feedback from the user indirectly.

In some embodiments, feedback component 150 may be configured to receive feedback from sensors 104. For example, feedback may be in the form of physiological, behavior, medical, or other information received from sensors 104. Examples of feedback received from sensors 104 may include heart rate, pulse rate, blood oxygen saturation, respiration rate, breathing information, physical movement or lack of movement, body position duration of movement, physical pain information, or other physiological information. Examples of behavior information may include the user demeanor, voice, look, gestures, manners, attitude, or other behavior information. For example, a feedback received from sensors 104 may indicate that the user is following the direction correctly based on his movement, body position, breathing, etc. Or, the feedback may indicate that the user is not following correctly (e.g., fall detection, or the user is breathing heavily, heart rate is too high, etc.).

In some embodiments, selection component 130 may be configured to select a second workout video block from the collection of workout video blocks. Communications component 140 may be configured to begin sending the second workout video block selected. The second workout video block may be selected based on one or more of the first workout video block, on feedback related to the first workout video block, on one or more user profile attributes, on groupings of the workout video blocks (e.g., body-region grouping, workout type groupings, etc.), on workout intensity level, on information obtained from other components of computing environment 100, or any combination thereof.

For example, in some embodiments, the second video block may be selected as part of a workout set. For example, the first video block selected was an upper body warm up exercise, the second video block will be a lower body warm exercise, a third video will be a stretching exercise. In this example, the first three videos are from the same workout set “warm up”. Subsequent video blocks may be selected from the same set or different sets (e.g., cardio, cool down, etc.). In some embodiments, the second workout video may be selected from the same body-region group at the same or different intensity level. For example, the first video block may include lunges, and the second may include squats, or dumbbell lunges. In some embodiments, the first video block is selected from one body-region and the second is selected from another body-region.

In some embodiments, selection component 130 may be configured to select the second workout video block based on feedback from sensors 104. A second workout video block may be selected by comparing a sensor reading with a target value. In some cases, the sensor reading may be compared to a value expressed in the user profile, a value that corresponds to a fitness goal, a value that corresponds to a progression of a workout regimen. For example, selection component 130 may select a video intensity based on comparison of heart rate reading and a target heart rate in the user profile (e.g., a faster workout if the heart rate is lower that the target value, and a slower workout if the heart rate is higher than the target value). In another example, the second video block may be selected based on compliance of the user with the first video block (e.g., if a movement sensor detects that the user stopped following the video, a different type of workout may be selected for the second video). For instance, embodiments may reference workout stream to identify what type of exercise is next, and then select among video blocks within that type of exercise based on real-time feedback (e.g., feedback during or within a few minutes of completing an exercise).

In some embodiments, communications component 140 begins sending the second workout video block before the first workout video block completes playing on the user device. For example, as soon as a feedback related to the first video is received (e.g., from the user, sensors 104, or other sources as described above with respect to feedback related to the first video block). In some cases, the second video block may be sent before the first video ends regardless of receipt of feedback. In some cases, the second video may be recalled before playing (or after it started playing) if a feedback is received that indicates that a different second video would be more appropriate. In this case, a different second video may be sent to the user. In some embodiments, communications component 140 begins sending the second video block after the first video completes playing. In some embodiments, a second video block may be sent within a predetermined period of time after the first video. For example, to give the user time to provide feedback or to give server 108 time to process feedback from sensors 104 or from other sources. In some embodiments, the second video is not played until the user selects to play it. In this case, the user may elect to play the video selected by selection component 130, or may select a different action (e.g., skip video, show me a different video, or browse the video blocks and select a video of his choice), or may provide additional feedback to guide selection component 130 in selecting a different video.

In some embodiments, one or more data structures may be used to organize information in computing environment 100 (e.g., information related to users, workout video blocks, sensors, and/or other information relevant to the functioning of computing environement 100). Examples of data structures that can be used include linked, array, associative array, record, variant data structures, or other types of data structures. In some embodiments, tagging component 160 may be configured to attach one or more attributes to the workout video blocks. In some cases, attributes may be attached to a video block based on interaction of the user with computing environment 100, or attached to a video block by a system administrator. Attributes provided by a system administrator may include workout, anatomical, trainer, injury, outcome, or other attributes. For example, workout attributes may include identifiers that describe the workout being performed by the trainer in the video block or the equipment necessary for the workout. Examples of workout attributes may include: Lunge, Push-Up, Burpees, dumbbells, kettlebell, etc. Anatomical attributes may include identifiers that describe body parts impacted by the exercises being performed in the video block (e.g., legs, core, foot, shoulder, upper body, lower body, etc.). Trainer attributes include identifiers that describe the trainers and coaching style (e.g., trainer name, gender, coaching style, or other information related to the trainer). Injury attributes include identifiers that describe injuries that may be impacted positively or negatively by the exercise and movements being performed (e.g., patellar tendonitis, calf strain, ACL tear, etc.). Outcome attributes include identifiers that describe fitness goals impacted by the exercises being performed (e.g., balance, power, strength, endurance, etc.). FIG. 3 illustrates an example 300 of a video block data structure including attributes provided by a system administrator.

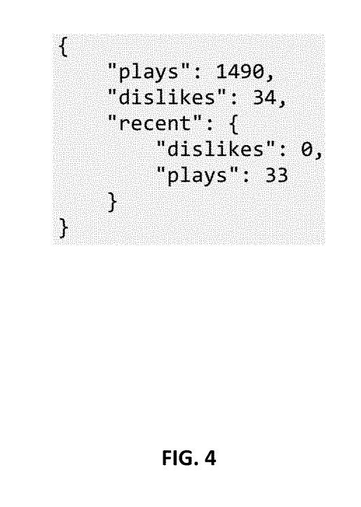

Attributes based on interaction of the user with computing environment 100 may be based on feedback provided by the user (e.g., accept, reject, skip, like, dislike, harder, easier, or other feedback provided by the user), feedback from sensors 104, feedback from other users, and or other feedback related to interaction of the user with computing environment 100. FIG. 4 illustrates an example 400 of feedback attributes.

In some embodiments, feedback may be obtained from a native application executing on the client computing devices to present videos, buffer videos, and communicate with servers 108 to effectuate workouts. In some cases, the application includes a user interface in which the video is displayed. In some embodiments, the user interface includes a plurality of inputs that, when selected by a user, cause messages indicative of a user input to be sent back to the servers 108 (or execute corresponding routines client side). In some embodiments, the inputs are regions of a screen overlaid on a video display, like touch-sensitive regions of a screen or clickable regions of a screen mapped to a corresponding event handler that is called upon a user input in the respective region. In some cases, the corresponding event handler may cause the client-side application to send a message back to the servers 108 indicative of the input.

In some cases, the client-side application may be distributed from a server controlled by an entity that provides an operating system of the client computing device. In some cases, an installation package for the application may include a security certificate signed with credentials of the provider of the operating system for security purposes. In some cases, the client-side application may accept other forms of input. For example, some embodiments may monitor a microphone of the client device for audio input indicative of user commands. For instance, some embodiments may execute on the client computing device a routine operative to detect utterance of a wake word in a stream of audio from the microphone. For example, some embodiments may use a wake-word of “your trainer.” (Limiting audio recognition to sequences following a wake word is expected to conserve battery and bandwidth in mobile contexts, but embodiments are not limited to implementations affording these benefits.) In some embodiments, the user may order “yourtrainer easier” or “yourtrainer harder.” Upon detecting the wake word, some embodiments may send a following audio stream from the microphone (e.g., for threshold duration of time, or until the stream is silent for a threshold duration of time) to a remote server for transcription to text, which may be returned to the client-side application or the server 1208 via a network. In some cases, some embodiments may compare the text to a set of patterns (e.g., regular expressions or n-grams) corresponding to different user inputs, and upon detecting a match, effectuate the requested operation. Thus, in some embodiments, a user may request an easier or harder workout video without touching a mouse or screen.

In some cases, the client computing device may include a camera or a range-imaging sensor, such as a time-of-flight sensor, a stereoscopic depth sensor, a structured light depth sensor, or the like. In some embodiments, the application executing on the client computing device may be operative to receive a sequence of images (in some cases with distance from the sensor and color associated with each pixel), like in a video. In some embodiments, an application executing on the client computing device may classify gestures appearing the sequence of images, or send the sequence to a remote server for classification. For instance, some embodiments may classify gestures with the techniques describe by Santos et al., in HAGR-D: A Novel Approach for Gesture Recognition with Depth Maps, Sensors 2015, 15, 28646-28664; doi:10.3390/s151128646.

In some cases, gestures may be classified according to indicate the various inputs described herein, e.g., moving a hand palm downward repeatedly between video segments may indicate a command to lower the intensity or vice versa. In some cases, the application executing on the client computing device may be configured to transmit the video over a local area network to another computing device on the same local area network, such as a set-top-box or smart television, and the video may be displayed on the other device, with a mobile device having the above-noted camera and range sensor positioned to image the user and receive these inputs.

In some cases, the gestures may be classified based on a video being displayed, e.g., by detecting an amount of difference between a movement in the video and that sensed in the imaging of the user. Some embodiments may automatically adjust the sequence of videos or cause instructions to be displayed responsive to these differences. In some cases, each video may be associated with a respective gesture classifier, and that classifier may be sent to the user computing device (or otherwise accessed, e.g., for those that are previously stored) when playing the video. Having an exercise-specific gesture classifier is expected to yield higher accuracy classification relative to systems that must also distinguish exercises. In some cases, the gesture classifier may be configured to output various scores indicative of the quality of the user's exercising, e.g., an amount of lag between movements in the video and those sensed, a frequency of movements in the video and those sensed, a range of movement in the video and those sensed. In some cases, the instructor, when the video is captured, may be subject to the same or a similar set of image sensors, and a timestamped stream of gestures (and associated parameters) may be captured and compared to those of the user. In some embodiments, differences therebetween, or parameters of the user's movement, may serve as one of the types of feedback described herein.

In some embodiments, equipment in a workout facility may include associated displays, such as tablets, computers, or smart televisions, mounted to (or adjacent) the equipment in a position such that the user can view the display (thereby freeing their hands), and in some cases, the gym-equipment-specific displays may execute an application configured to receive video instructions from the user computing devices that cause those displays to present a workout video obtained via the user computing device. In some cases, videos pertaining to exercises on the equipment may be pre-cached and stored in memory of the equipment-mounted displays, or in some cases, video may be streamed from the user computing device to those displays, for example, with Miracast™, Chromecast™, WebRTC, or various peer-to-peer protocols, for example, via a local area Wi-Fi network, e.g., pulling from video cached locally to reduce bandwidth usage and lower latency relative to video sent from a remote server. Or in some cases, video may be streamed from a remote server. In some embodiments, workout facilities may also include kiosks having computing devices and associated displays by which users may input attributes of their workout, provide feedback, or view instructions.

In some embodiments, other sensors may be used to quantify or qualify the user's exercises. For example, some embodiments may obtain a stream of readings from an inertial measurement unit associated with a mobile computing device or a wearable computing device (e.g., one attached to the user) and extract features indicative of the quality of exercises. For example, some embodiments may execute a dynamic time warp algorithm to pattern match a stream of inertial measurement unit readings (e.g., with a sequence of time-stamped acceleration measurements in three or six dimensions from gyroscopes or accelerometers) to classify or extract features from an exercise being for performed, e.g., measure a range of movement in such an exercise, measure a frequency of such an exercise, or the like. Some embodiments may classify or score a user's form and repetitions of an exercise according to patterns matched by this stream of data. In some cases, exercise-specific classifiers or feature-extractors may be downloaded or selected based on a current video to reduce a search space for the algorithms and improve accuracy, using techniques like those described elsewhere for classifying gestures in images.

In some embodiments, input may be provided via a wearable computing device or videos or audio may be presented via the wearable computing device. For example, in some cases, audio input or touch input may be input on a wearable computing device, like a smartwatch. In some cases, this wearable computing device may interface with an instance of the user computing device described above executing an application interfacing with servers 108, or in some cases, the wearable computing device may serve as the user computing device.

Some embodiments may also include video blocks that pertain to things other than exercises. For example, some embodiments may use the techniques described above to infer that particular habits would be helpful for the user and select videos advocating for and educating it about those habits. For example, some embodiments may follow a workout with the video block instructing the user to drink 64 ounces of water, to stretch, to engage in particular nutritional patent practices.

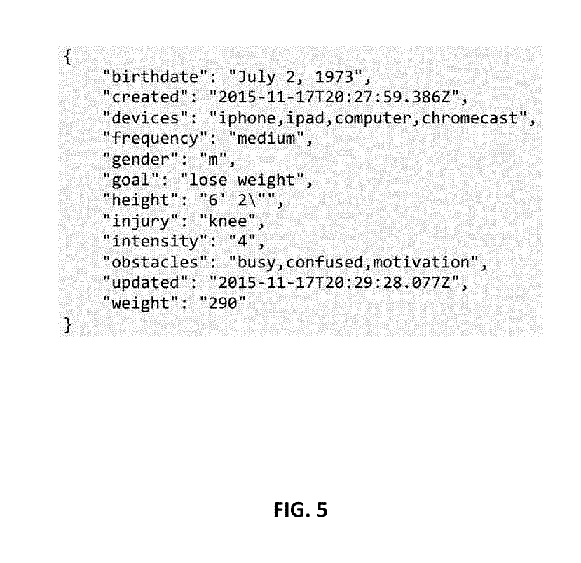

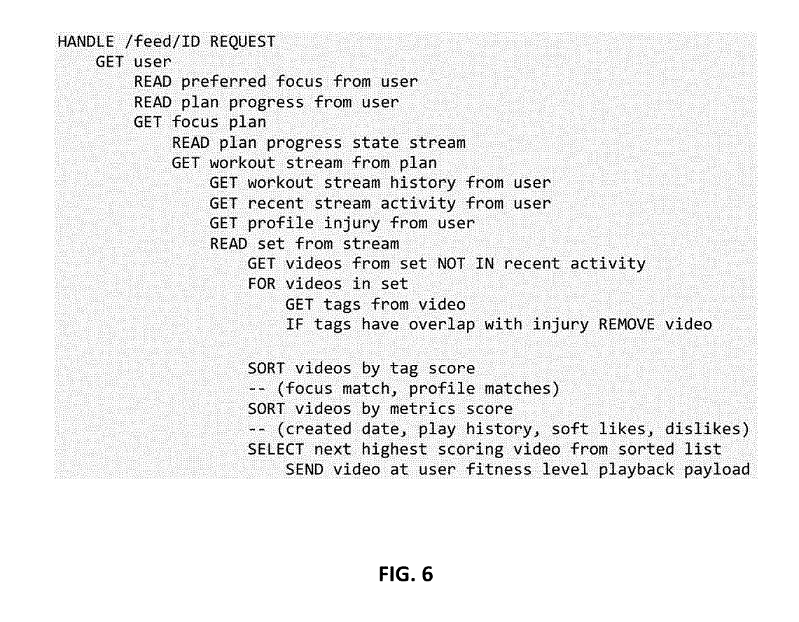

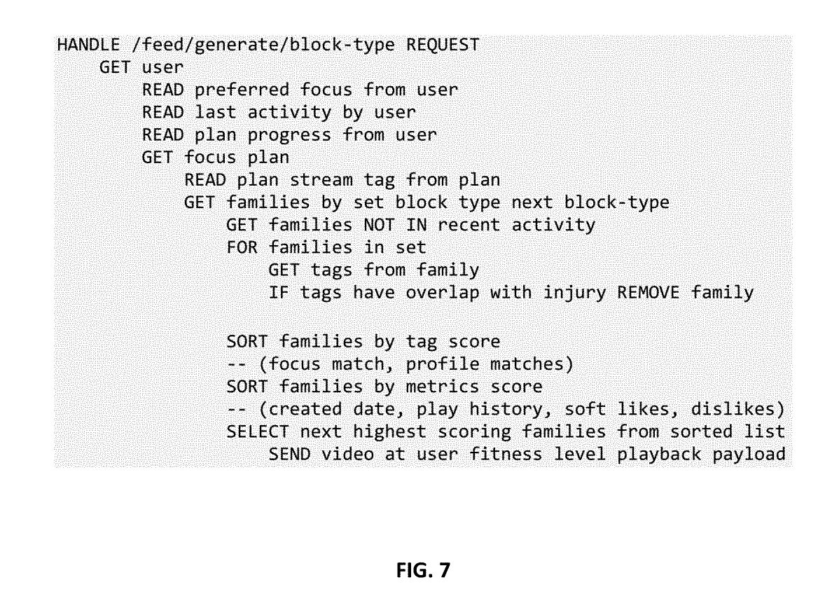

As shown in FIG. 1, organization component 170 may be configured to sort the video blocks by using an attribute score. In some embodiments, the attribute score is a function of one or more of the video blocks attributes (described above), or the user profile attributes (described above). FIG. 5 illustrates an example 500 of user profile attributes used by organization component 170. For example, in some cases, the attribute score may be a function of one or more of the workout attribute, the anatomical attribute, the trainer attribute, the injury attribute, the outcome attribute, the feedback attribute, or the user profile attributes. As indicated above, the user profile attributes may include information received from sensors 104. In some embodiments, the video blocks may be ranked based on their attributes score and based on the user profile attributes. For example, a highest scoring video block may be selected to be presented to the user. FIGS. 6-7 illustrate examples 600 and 700 of video selection based on scored attributes.

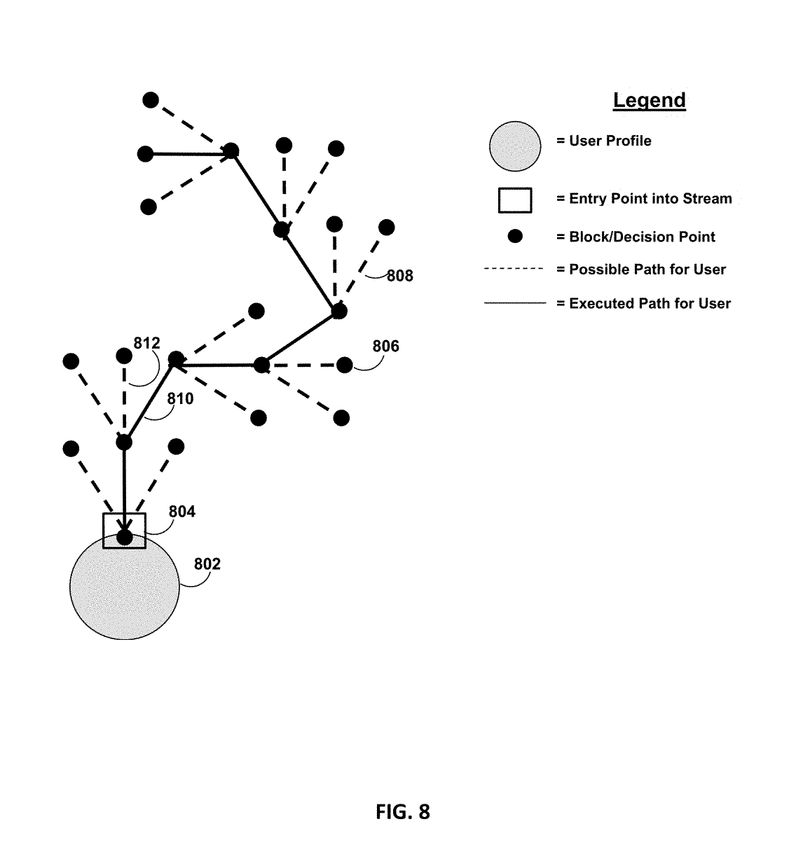

FIG. 8 illustrates an example state diagram of video block sequencing. In operation in this example, personalized workout video creation servers 108 dynamically creates the user's workout by first accessing their profile (represented by the circle 802) and the profile attributes, including information such as time since last workout and external data from sensors (e.g., wearables). This interaction is represented by square 804. The results of this check are used to select a correct first block (represented by a solid black dot 806) to present to the user. In some cases, the selection may be made according to a supervised machine learning model trained with the techniques described below. Once a block is active, the user has several actions or inaction they can execute, such as “skip,” “harder,” “easier,” or “complete.” that will determine their path through the system. The lines from each decision point represent either possible paths to next blocks (dotted line 808) or actual path taken (solid line 810), where the middle line 812 is the path if the user takes no action. Decisions made by servers 108 based on action, or inaction by the user are stored in order to be recalled at a later time, e.g., for use in the training sets described below. The goal of servers 108 is to learn the attributes and behaviors of the user so that the user's path becomes more linear, indicating the system is improving its ability to present the most correct block for the user at that time. In some cases, selections may include a non-deterministic input, for instance a random or pseudo random value (like determined with a linear shift register), and subsequent videos may be selected based on whether less-significant digits of their identifier corresponds to (e.g., is closest to) the random value. In some cases, candidate subsequent video blocks may be selected according to the techniques described herein, and selection among the qualified candidates may be non-deterministic to keep the routines interesting for the users.

In some embodiments, users of computing environment 100 may share, request to share, or request to view workouts data, performances, engage in games, or competitions, through computing environment 100, or via other ways. Computing environment 100 may provide the user with workout data from another user device. For example, a user may elect to have a notification sent to other people (users or non-users of computing environment 100) whenever he completes a workout. Such notifications may be sent via computing environment 100 (for other users), or via email, text, tweet, Facebook post, or other ways of sending notifications to other people. In some embodiments, the notification may include information about the workout, performance, pictures, videos, etc. Users of computing environment 100 may challenge each other, rate each other, provide feedback to each other, or engage in other social interactions. In some embodiments, computing environment may provide the user with an anonymous comparison with other users of the system. For example, rank the user relative to other users based on performance, number of time the user workouts, fitness, weight loss, etc.

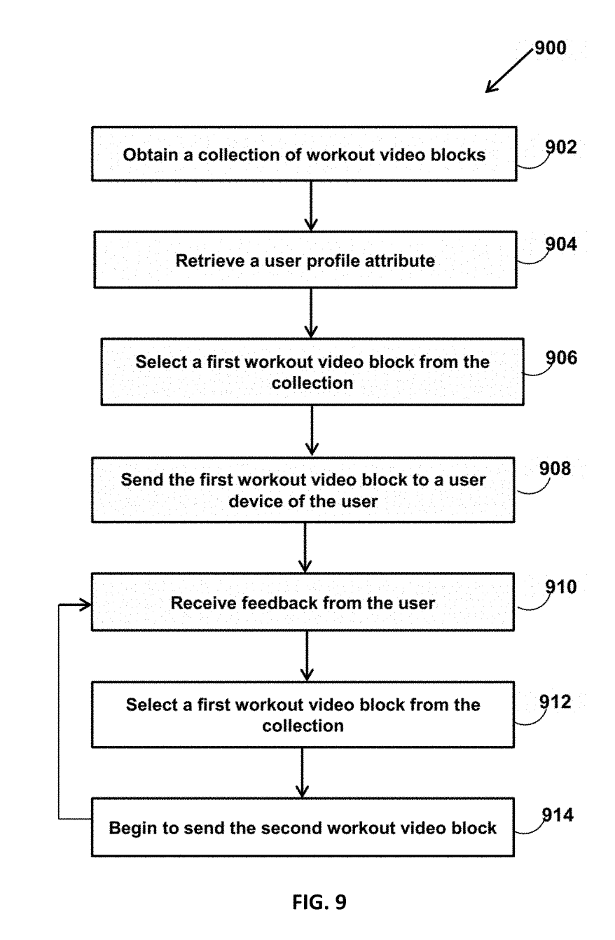

FIG. 9 illustrates a method 900 for dynamically creating a personalized workout video for a user in accordance with one or more embodiments. The operations of method 900 presented below are intended to be illustrative, which is not to imply that the above discussion is intended to be limiting. In some embodiments, method 900 may be accomplished with one or more additional operations not described or without one or more of the operations discussed which is not to imply that any other component is limited to the features described. Additionally, the order in which the operations of method 900 are illustrated in FIG. 9 and described below is not intended to be limiting, which is not to imply that any other component is limited to the features described.

In some embodiments, one or more implementations of method 900 may be implemented in one or more physical processing devices (e.g., a digital processor, an analog processor, a digital circuit designed to process information, an analog circuit designed to process information, a state machine, or other mechanisms for electronically processing information). The one or more processing devices may include one or more devices executing some or all of the operations of method 900 in response to machine-readable instructions stored electronically on one or more electronic storage mediums. The one or more physical processing devices may include one or more devices configured through hardware, firmware, or software to be specifically designed for execution of one or more of the operations of method 900.

As shown in FIG. 9, at an operation 902 of method 900, a collection of workout video blocks, may be obtained. The collection may include a plurality of body-region groupings of the workout video blocks. Individual body-region grouping may include a plurality of the workout video blocks designated as having different workout intensity. In some embodiments, operation 902 may be performed by an access component the same as or similar to access component 120 (shown in FIG. 1 and described herein).

At an operation 904, a user profile attribute may be retrieved from a user profile. The user profile attribute may include a fitness goal or an exercise constraint. In some embodiments, operation 904 may be performed by an access component the same as or similar to access component 120 (shown in FIG. 1 and described herein).

At an operation 906, a first workout video block may be selected from the collection. The first workout video may be selected based on both the fitness goal or the exercise constraint and an intensity level or body-region grouping of the selected first workout video block. In some cases, the selection may be made according to a supervised machine learning model trained with the techniques described below. In some embodiments, operation 906 may be performed by a selection component the same as or similar to selection component 130 (shown in FIG. 1 and described herein).

At an operation 908, the first workout video block may be sent to a user device of the user. In some embodiments, operation 908 may be performed by a communication component the same as or similar to communication component 140 (shown in FIG. 1 and described herein).

At operation 910, feedback from the user indicative of a user response to the first workout video block may be received. The feedback may be received after beginning to sending the first workout video block. In some embodiments, operation 910 may be performed by a feedback component the same as or similar to feedback component 150 (shown in FIG. 1 and described herein).

At operation 912 a second workout video block may be selected from the collection. In some cases, a session record may be updated to indicate the user has advanced to a next stage of a workout stream, e.g., from legs to back. The second video block may be selected based on the feedback, the intensity of the second workout video block, a current state of the user in a workout stream, and a body-region grouping of the second video block. In some embodiments, operation 912 may be performed by a selection component the same as or similar to selection component 130 (shown in FIG. 1 and described herein).

At an operation 914, the second workout video block may begin to be sent to a user device of the user. In some embodiments, operation 914 may be performed by a communication component the same as or similar to communication component 140 (shown in FIG. 1 and described herein). Operations 910-914 described above in a feedback loop manner.

Dynamic selection of video blocks may be performed with a variety of techniques. In some cases, rules may be hard coded, and selection may be according to a rules engine executing those rules according to information in a user profile and current feedback. In some embodiments, a machine learning models may be trained to select video blocks. Due to the temporal sequence of video block selection, some embodiments may train other types of models, for instance, a Hidden Markov model or a recurrent neural net.

For instance, a first model may be trained to select a workout instructor appearing in the blocks. Embodiments may ask users to rate their workout instructor and associate those ratings with the user's profiles. This data may be used as a training set. Embodiments may then determine weights or coefficients of a model, for instance a neural net or decision tree, by iteratively adjusting the coefficients, determining how closely the model describes the training set, and then adjusting the weights or coefficients in a direction in which the correspondence is expected to increase. The resulting model may then receive as an input a current user's profile and, based on the trained weights and coefficients, a score or selecting of candidate workout instructors may be determined to identify the best fit for the user based on the training data.

Using a similar technique, a workout routine for the workout instructor may be selected. Again, a model may be trained by asking users to rate their experience with the different routines, or workout streams, and a workout stream model may be trained. This model may then be used to determine which workout stream for the chosen instructor the user will experience.

Similar techniques may also be used to select workout blocks within each stage of the stream. In some embodiments, users may be asked to rate each exercise, and the user's current and immediately preceding feedback may form a training set along with the rating. Once trained, this model may be used to select subsequent videos blocks for other, similarly situated users providing similar real-time feedback.

Some embodiments may include an interface by which a personal trainer may augment the user's experience with the application. For example, some users may meet with a personal trainer relatively infrequently, like once a month to obtain guidance. In some embodiments, a personal trainer may log into the application in a personal trainer account and submit recommendations to be added to a given user's account. In some cases, these recommendations may be adjustments to the weightings described elsewhere herein by which various exercises are chosen or may be templates for workouts. In some cases, these recommendations include a schedule for workouts as well. Some embodiments may then adjust recommended workouts according to the submitted personal trainer recommendations. In some cases, embodiments may gather data about the efficacy of the workouts and store the data in the user's profile. Some embodiments may then provide a dashboard or other user interface by which a personal trainer may view those metrics and diagnose issues with the user's workout regimen. In some cases, this process may be repeated periodically, for example monthly, such that the user benefits from a personal trainer, but requires relatively infrequent contact with a personal trainer due to the intelligence added by the present systems. In some embodiments, the data in the dashboard viewed by the trainer may include the data described elsewhere herein indicative of the quality of exercises, including gesture classifications, gesture feature detection, gesture scoring, biometric measurements, like heart rate, pulse oximetry, and the like. In some cases, the data is extracted from a wearable device that includes data both indicative of training and indicative of other aspects of the person's life, for example sleep patterns, weight, body fat percentage, and the like. In some cases, the data may be gathered by other sensors associated with the user, for example, Internet-of-things appliances in the user's home (e.g., network connected scales and body-fat sensors) and wearable computing devices associated with the user (e.g., a smart watch having a pulse sensor, an inertial measurement unit, and a pulse oximeter operative to measure blood oxygen levels).

In some embodiments, the application executing on the user computing device, upon determining that the user is in a workout facility, may automatically pause upon the completion of one exercise to give the user time to transition to another piece of equipment to which the application directs the user. Some embodiments may include a input by which the user indicates that have arrived at the other piece of equipment that are ready to proceed or input by which the user indicates that the other piece of equipment is used in request a different video block consistent with the user's workout.

In some embodiments, a machine-learning model may be trained to select workouts based on a user's goal. For example, in some cases, a training set may include a goal set by previous users, profiles of those users, workouts by those users, and an indication of whether the users achieve their goals. Some embodiments may filter the training set according to whether users satisfy their stated goals. Some embodiments may cluster users (e.g., with a density based clustering algorithm, like DB-SCAN) according to profiles to identify groups of users who are similar to one another, for example, of similar profiles and have sent similar goals. In some cases, some embodiments may then detect features of workouts within each of the clusters, for example, patterns in chosen workouts associated with meeting the goal for those in the cluster. For instance, for each cluster, embodiments may train a decision tree to classify users as likely to meet their goal based on workout history. Some embodiments may then use these detected features and clusters to recommend workouts for other users. For example, some embodiments may receive a request for workout from a given user, determine which cluster most closely matches that given user, and then select a workout for that user that includes the futures detected among the users in that cluster within their workouts.

In some embodiments, some or all of the weights or coefficients described herein may be calculated by executing a machine learning algorithm on a training set of historical tagged data, e.g., user ratings and the state of the user's account. Some embodiments may execute a gradient descent optimization to reduce the error rate and select appropriate weighting and the threshold values, such as those used in filtering. In some cases, a predictive model (e.g., a vector of weights) may be calculated as a batch process run periodically. Some embodiments may construct the model by, for example, assigning randomly selected weights; calculating an error amount with which the model describes the historical data and a rates of change in that error as a function of the weights in the model in the vicinity of the current weight (e.g., a derivative, or local slope); and incrementing the weights in a downward (or error reducing) direction. In some cases, these steps may be iteratively repeated until a change in error between iterations is less than a threshold amount, indicating at least a local minimum, if not a global minimum. To mitigate the risk of local minima, some embodiments may repeat the gradient descent optimization with multiple initial random values to confirm that iterations converge on a likely global minimum error. Other embodiments may iteratively adjust other machine learning models to reduce the error function, e.g., with a greedy algorithm that optimizes for the current iteration. The resulting, trained model, e.g., a vector of weights or thresholds, may be stored in memory and later retrieved for application to new calculations on newly calculated aggregate estimates.

In some embodiments, video blocks may be selected for a given user in a given session by training a machine learning model with a training set. Some embodiments may obtain a training set from previous sessions. Each record in the training set may include inputs to a given session, including: the user's profile, the user's previous workouts (e.g., a list of video blocks, or attributes thereof. Each record in the training set may include a sequence of video blocks presented in the session based on the inputs. And each record may include feedback from the user indicative of the success of the workout in that session: e.g., an amount of changes in the video block (e.g., requesting increases or decreases in intensity, different exercise or body groups, different durations, different frequencies, different instructors); biometric feedback from one of the above-described sensors; or whether the user persisted with a subsequent workout within some duration of time (e.g., did they return within at least one week for another workout). In some cases, some embodiments may calculate a feedback score based on one or more of these factors for each session in the training set, e.g., a weighted combination of values, or one value may be chosen as the sole measure.

In some embodiments, a recurrent neural network may be trained to suggest subsequent video blocks based on the types of inputs noted above in the training set. In some embodiments, the model may include a graph of perceptron that is cyclic, with at least some outputs of some neurons feedback into themselves or other perceptrons that feedback eventually into those perceptron. Some embodiments may train a Long Short Term Memory network (LSTM) with the training set, e.g., with backpropagation through time, using a technique like that described above for gradient descent parameter selection.

In some embodiments (e.g., in some cases where the feedback is non-differentiable), video blocks may be selected for a given user in a given session by a discrete hidden Markov model (HMM) trained to suggest subsequent video blocks based on the types of inputs noted above in the training set. For instance, some embodiments may train a HMM with the Baum-Welch algorithm or the Baldi-Chaivin algorithm. Some embodiments may infer a transition probability matrix between different exercises (or sequences of previous exercises and other time-varying inputs in a multi-level HMM) by fitting values of the transition probability matrix to the training data, e.g., selecting values that maximize a measure of fitness for the transition probability matrix in explaining the training data.

In some embodiments, these various models may be trained periodically in a batch process, e.g., daily, weekly, or monthly. In some embodiments, the models may then be accessed when selecting video blocks. A next video may be selected responsive to a variety of signals, e.g., in response to determining that a given video block that is playing reaching a threshold duration (like within 20 seconds of the video block ending), or in response to an event handler receiving user feedback (e.g., upon receiving a message from client computing device with a session identifier and an associated feedback value, like “favorite,” “dislike,” “easier,” or “harder.” Some embodiments may then input a current state of a user profile and session to one of the above-described models, which may output scores selected with each candidate video block (e.g., one for every video block, or one for every video block subject to a constraint imposed by a stage in the workout, like one specifying than the next video block should relate to arms or legs or be lower intensity or higher intensity than a current video block). Some embodiments may then select a candidate video block having a highest score as indicated by the model, e.g., a strongest perceptron output in a neural net, or a highest transition probability, or the like.

In some embodiments, different models may be trained for different stages of a workout, e.g., one for warmup, one for the core of the workout, and one for cooldown; or one for legs, one for arms, one for chest, etc. Or some embodiments may train different models subject to different constraints. For instance, some embodiments may train a model subject to the constraint of a knee injury, e.g., selecting records in the training set corresponding to this condition, and manually constraining candidate outputs based on instructions by a medical professional as to what is an appropriate candidate. Or some embodiments may train (and access to select video blocks) different models for different segments of users, e.g., those having particular attributes, like a gender, age range, preferred intensity, or the like.

In some embodiments, the model may be trained with different initial conditions (e.g., arbitrarily chosen parameter values, like randomly chosen parameter values). Some embodiments may compare the fitness of models produced with the different initial conditions and select a candidate model having the best measure of fitness. This approach is expected to mitigate the risk of models optimizing to a local minimum in the parameter space.

In some embodiments, some of the training data may be segmented for different training sessions on different segments. For instance, 10% segments of the training data may be used to train a model 10 times (e.g., with differing initial conditions), and resulting models may be compared. Some embodiments may select a model with a highest amount of fitness among the candidates as measured with the metrics described above.

In some embodiments, some of the training data may be withheld for cross validation. For instance, some embodiments may withhold 10% of the training set and not use withheld data to train the above models. Some embodiments may then calculate an aggregate measure of fitness on the withheld data with the trained model, e.g., using the metrics described above, e.g., an aggregate amount of error (e.g., a total or average root-mean-square error) between predicted feedback scores and observed feedback scores given a set of inputs. Some embodiments may discard models that have worse than a threshold measure of fitness or cause an alarm to be presented to a technician.

The present techniques have been described with reference to video, but it should be appreciated that similar approaches are also contemplated for other forms of media. For instance, some embodiments may sequence audio for workouts with the present techniques. Some embodiments may sequence video (or three-dimensional renderings) for virtual reality displays. In some cases, the above-described gesture classification techniques may be applied in a VR environment, e.g., based on positions of hand controllers or other position tracking systems. For instance, some embodiments may detect a flaw in a user's form in an exercise and select a video by which correct form is demonstrated or display text or present audio by which the user is instructed in how to correct their form. Some embodiments may send text descriptions of workouts, e.g., listing them by name.

Some embodiments may provide for various forms of live, real-time communication between fitness clubs, trainers, and users. Some embodiments provide the ability for one fitness club to broadcast their classes or events live or via recording for consumption on user computing devices, like those described above. In some embodiments, a fitness club associated with a plurality of the above-described workout facilities, may have an account in a data repository of the above-described servers. In some embodiments, such servers may include a content management system operative to receive video feeds or recordings from fitness clubs and stream those videos to user computing devices. Some embodiments may log information from the user computing devices like that described above in association with streaming of the video, for example to update user profiles. Some embodiments may provide the ability for one fitness club to broadcast some or all of their classes live for consumption in other fitness clubs. In some embodiments, some embodiments may selectively provide access to such video content upon a user subscribing to such a data feed or indicating that they have enrolled with a fitness club to which such a subscription has been provided. Some embodiments may provide the ability for class participants, either in class via a class-wide shared computing device, or on a personal user computing device, to communicate with one another. For example, some embodiments may include a messaging service and related social network by which users may communicate via text, audio, or video. In some cases, messages may be sent to an entire class or certain participants therein.

Some embodiments may provide various refinements on the techniques above directed towards users. For example, some embodiments may select and provide exercise tutorial videos or audio files dynamically according to user profiles. For example, some embodiments may show different tutorials to different users in response to the different users indicating different injury states. For instance, some embodiments may show a different squat exercise tutorial video to someone with a knee injury than to someone with a knee injury. Further, some embodiments may provide the ability for users to view dynamic workout videos in a seated position, within a limited sphere of movement, e.g., for consumption in a moving transportation device, for instance, in a car, train, or airplane. In some cases, a user may input such constraints via the user computing device, and such constraints may be applied with techniques like those described above for selecting workouts in accordance with injuries, another form of a constraint. Some embodiments may further provide the ability to select dynamic workouts in accordance with other constraints.

Some embodiments may dynamically adjust intensity of selected video blocks or exercises in accordance with external factors, like temperature, rain, humidity, and the like. Some embodiments may subscribe to a third-party weather API and, periodically or in response to a request, ingest data from the third-party weather API indicative of such factors. Some embodiments may automatically adjust workouts, for example, adjusting workout video block selections, responsive to these factors. For example, some embodiments may select a less intense workout responsive to higher temperature or humidity. Further, in some cases, weather like rain may serve as a constraint like those described above, and embodiments may select workouts in accordance with such a constraint.

Some embodiments may be configured to suggest food or drink for users to consume, for example, after a workout or between workouts. For example, some embodiments may present maps to particular grocery stores based on user's current location, suggest deals on products available at those grocery stores, and provide shopping lists for recipe selected in accordance with a user's workout goals and user profile. In some cases, the selections may be made dynamically responsive to how a user performed in a previous workout. Using similar techniques, some embodiments may automatically suggest various forms of therapy after a workout, for example, instructing the user to go to a particular massage therapist or sports doctor after a workout, for instance, in response to user feedback provided during the workout. Some embodiments may maintain a geographic information system with geolocations of such providers and select providers and make recommendations based on both user profile distance, e.g., based on a user location being proximate to (e.g., within a threshold distance or travel time) providers of such services.

Some embodiments may suggest trainers or friends for a user to work out with. Some embodiments may cluster users and trainers according to various criteria, for example, attributes of user profiles, like goals or workout patterns. For instance, some embodiments may model users as feature vectors, with user profile attributes like workout goals, performance, timing, and feedback being mapped to scalars of the vectors. Some embodiments may cluster the vectors with a DBSCAN algorithm and suggesting pairings. Or some embodiments may rank pairings based on Euclidian distance in the vector space, e.g., suggesting to a user the five closest other users or trainers.

Similarly, some embodiments may suggest workout equipment with users for users to work out with. For example, some embodiments may suggest that a user begin training with dumbbells. In some embodiments, the techniques described above by which exercises are selected may be used to select workout equipment as well.

As noted above, the techniques described with reference to FIGS. 1 through 9 may be generalized and made more responsive to events in a user's life within approach described below with reference to FIGS. 10 and 11. In some cases, the above-described workouts may be generalized to sequences of user fitness-related needs described below. Further, the individual selected workouts may be generalized to fitness-related activities that are prescribed with the techniques described below. Thus, the above-described computing environment, data structures, rules and machine learning techniques, among other aspects described above, are applicable to some embodiments of the approaches described below with reference to FIGS. 10 and 11. It should be emphasized, however, that the techniques described below with reference to FIGS. 210 and 11 are not limited to systems employing all or any of the above-described features, which is not to suggest that any other description herein is limiting. In this system, events (such as triggers) activate prescriptions based on the target user's profile and needs. The data model and operational principles are described first, followed by details of example implementations.

Events may take various forms. Events generally are measurable inputs that the engine reads to activate its decision process to create a prescription. Example events include the following: User opens app; User checks into a health club; User checks into a flight (read through 3rd party API integration); User checks into a hotel (read through 3rd party API integration); User opens calendar on their mobile device; User geo-location indicates arrival/departure of a location (e.g., as reported by the user's mobile device upon the device traversing a geofence of a fitness club, their home, their work, a hotel, an airport, or a city); User wakes up (read through 3rd party data); User finishes workout within the system (e.g., completes one of the above-described videos); User finishes workout external to system (e.g., as noted in a manual report via the native app); User finishes workout external to system (read through 3rd party API data); User Inactive for a threshold number of hours (e.g., as reported by a fitness tracker of the user or responsive to IMU readings of their mobile computing device); User calendar change (e.g., as reported by third party API); User logs meal (data read through 3rd party API); Heart rate change reported by biometric sensor on fitness tracker; Blood pressure change reported by the same; Hydration level change reported by the same; Weather report change from third party API; User signs up for wedding or baby registry as reported by 3rd party API; or User signs up for athletic event like a 10 k or marathon as self reported or by a 3^{rd} party API.

User profiles may include the features of user profiles described above. In some cases, a user's profile is a set of data collected from various sources that define exactly who the user is currently, what their health and fitness history has been in the past, and what they want to achieve in the future. The engine, in some embodiments, takes some or all of these factors as inputs when determining based on these inputs what is most appropriate to prescribe at any given moment responsive to an event. Example profile elements include the following: Age; Gender; Height; Weight; Body Composition; Blood Panel; Hormone Panel; DNA (or genes therein); Profession; Current Fitness Level; Current Fitness Habits; Current Injuries; Injury History; Fitness Goals; Emotional/Stress Goals; Access to Resources (like Equipment, Space, Devices, Attire, or People); Fitness Preferences; Personality Type; IQ; Learning style; Home Address; Work Address; Workout History; Activity History; Current Fitness Knowledge; Schedule; Devices (like Phone, Tablet; Computer; Smart Speaker, Smart TV, Smart Watch, VR System, AR system or accounts thereon); and User Role (like Client, Trainer, Nutritionist, Athlete).

Some embodiments are expected to simulate much of what a personal coach provides to a user. As such, the user's needs in any given moment may be an input for determinations as to what to prescribe. For example, when a user completes a workout, they may need to know if they achieved the desired effort, celebration of their accomplishment, and guidance on what to do next. Each of these needs can be fulfilled by a prescription. Example User Needs include the following: Guidance—what should the user do next; Motivation—why should a user want to take action; Affirmation—has the user taken the correct action; Celebration—make the user feel good about their accomplishment; Education—empower the user to make their own decisions for their health; Accountability—insure the user does what they are supposed to do; Connection—help the user meet and communicate with people on similar journeys; Entertainment—make the user enjoy their efforts; Equipment—what equipment the user needs to assist them; and Professionals—what professionals will be able to help them.

A prescription may be made, in some embodiments, by combining resources, a call to action (CTA) (if applicable), prior knowledge of the successful uptake of prior prescriptions and the actual outcome of acted upon prescriptions. Example CTAs include the following: Schedule; Start; Share; Purchase; Reserve; Sign Up; Join; Share; Review; Watch; Read; Listen; Smell; and Touch. CTA's that can be effectuated with a computer-implemented resource may be presented with a link to that resource (e.g., an URI, such as a URL or an intent registered to some application or service on a user's mobile device).

In some embodiments, resource categories may be split into two or more categories, such as intangible and tangible. Intangible resources are ones that derive their utility form information content, such as records that exist in a database, or other non-rivalrous resources. Tangible resources are ones that have utility beyond their informational content (but may have a digital representation), such as rivalrous goods. For example, a person may be a tangible resource represented in the database via a defined profile. Intangible Resource Examples include the following: Videos; Lists; Games; Articles; Plans; Challenges; Group Exercise Class Reservations; Personal Training Reservations; Nutritional Recommendations; Recipes; Songs; Music Playlists; Haptic feedback; and Sounds. Tangible Resource Examples include the following: People (like Personal Trainers, Group Exercise Instructor, Nutritionist, Physical Therapist, or Sport Coach; Spaces (like Health Clubs, Workout Rooms, Hotel Workout Rooms, Basketball Courts, Tennis Courts, Volleyball Courts, Pools, Tracks, Hiking Trails, Bike Trails, Parks, Lakes, or Public Beaches); Equipment (like Dumbbells, Kettlebells, Barbells, or Treadmill); Tools (like Heart Rate Monitors, Wearable Activity Trackers, Mobile Devices, or Smart Home Devices); and Apparel (like Shoes, Pants, Shirts, or Gloves); Multi-sensory items (like Smelling Salts, Candles, or Food)

In some embodiments, prescriptions are analyzed to determine the prior uptake of the prescription and what was the actual physiological outcome from users completing the prescription, for instance, specifically what percentage of users act on the prescription and what is the quantitative outcome to ensure the delivery of an optimal prescription.

Prescriptions may be delivered through a GUI on the native application on the client device (or a web application in a browser). Example Prescriptions Delivered through Graphical User Interface (GUI) include the following: “Schedule a 30 Minute Treadmill Run at Gym”; [CTA] a [Digital Resource] at [Physical Resource]”; “Reserve a 60 Minute Personal Training Session with John”; [CTA] a [Digital Resource] with [Physical Resource]”; “Start your 24 Minute Total Body Training Adaptive Video Workout”; [CTA] your [Digital Resource]; “Read ‘5 Foods to Avoid for Weight Loss’”; [CTA] [Digital Resource]; “Listen to ‘Pump Up Playlist’ during your 30 Minute Run on Townlake Trail”; [CTA] to [Digital Resource] during your [Digital Resource] on [Physical Resource]; “Purchase this Yoga Mat for your next Foundations Yoga Session”; or [CTA] this [Physical Resource] for your next [Digital Resource]. Bracketed items are examples of variables in example prescription templates. Example Prescriptions Delivered without GUI include the following: {Smart Home Smart Lights Slowly start fading to indicate it is time for bed}; {Smart Watch Vibrates Three times fast to indicate time to stretch}; or {Treadmill automatically adjusts to prescribed speed and incline}. Prescriptions can be delivered on various channels, including through the following: In-App; In-Club Check-in; In-Club Kiosk; Email; Push; Smart Speaker; Smart TV; Smart Watch; Smart Home; Personal Trainer; Connected Fitness Equipment (e.g., Treadmill, Bike, Rower, etc.); or Wearable Fitness Tracker.

Resources may be scored and otherwise tagged to facilitate prescriptions. Some embodiments implement a tagging taxonomy that classifies the resource, scores the resource (when applicable), and describes the resource attributes. Tags may include one or more of the following four different types of tags: Classifying; Scoring; Describing; and Artificial Intelligence (AI). The Classifying Tags may have three or more distinct tags that define where the resource exists in the ecosystem:
a. Classification—may define or otherwise indicate what the resource is. The number of classifications may be expansive. Examples are found in the above section “Resources”.
b. Category—define or otherwise indicate the general topic to which the resource belongs. Examples include: Movement, Nutrition, Recovery, Psychological, and Administrative.
c. Purpose—defines or otherwise indicate how the user is intended to interact with the resource. The three example types of purposes are the following: Perform—the resource directs the user to take action, Inform—the resource educates the user, and Entertain—the resource can be consumed for pleasure.

The Scoring Tag section may have several (e.g., four or more) tags that define the resources appropriateness for prescription. For brevity the following definitions and examples primarily use Classification=Video, Category=Movement, Purpose=Perform.
a. Focus—defines or otherwise indicate the composition of the resource and is measured in relative percentages. For example, a workout video might have 80% of its exercises be strength training, and 20% of its exercises be endurance training, so its focus score is: Strength=80%, Endurance=20%. These may be compared against respective thresholds in user needs to select resources.
b. Intensity—defines or otherwise indicate the level of physical effort needed to execute the resource. This may be measured against an absolute scale of 0-12, where 12 is the upper conceivable limit of human effort. An example correlation of ability is as follows: Beginner=3, Intermediate=6, and Advanced=9. These may be compared against a score in user profiles as a threshold to select resources according to intensity.
c. Discipline—defines or otherwise indicate the methods employed to execute the given resource. While “Strength” is a universal focus for many types of physical activity, the discipline of “Yoga” uses very different techniques to achieve strength than the discipline of “Olympic Lifting”. Example disciplines: General Fitness, Yoga, Pilates, Olympic Lifting, and Barre.
d. Proficiency—defines or otherwise indicate the complexity of the techniques being used within the defined discipline. This may be measured against an absolute scale of 0-12, where 12 is the upper conceivable limit of mastery. An example correlation of ability is as follows: Beginner=3, Intermediate=6, and Advanced=9. These may be compared against a score in user profiles as a threshold to select resources according to proficiency.

Thus in some cases, the Proficiency Tag group differs from the Intensity group in that it is a measure of skill and not effort. Something can require very little skill (e.g., a squat) but be very challenging to execute because of volume and load (e.g., 100 squats while holding 100 pounds).

Scoring Tags may pertain (e.g., only pertain) to resources that can be prescribed to a user without an additionally defined use case. For example, a resource defined as a Classification=Video, Category=Movement, and Purpose=Perform may have an inherent use case, in that it is presumed a user can follow along with the video to get a workout. In this case the resource may require appropriateness for a user be scored. This may be relevant for a workout video that is extremely intense and difficult to perform, and may be analyzed to determine that it is not prescribed to a user brand new to fitness, deconditioned, and with little experience. But if a resource is defined as Classification=Equipment, Category=Undefined, and Purpose=Undefined, then the resource may need to be combined with other resources in order to create a use case to be prescribed.

For example, a treadmill may be a Tangible Resource with no inherent use case. It may involve a combination with an Intangible Resource (e.g., a “30 Minute Running Session”) to have a use case to be prescribed. In this example, the Intangible Resource “30 Minute Running Session” is defined with Scoring Tags that determine, at least in part, whether or not the prescription would be appropriate for the targeted user.

The Description Tag section may further define or otherwise describe the resource by detailing the specific attributes of the resource, such as un-scored attributes. The list of attributes may be expansive and may include the following:
a. For Resource=Video: Publisher, Duration, Publish Date, Production Location, Camera Type, Camera Count, Set Type, Primary Coach, Secondary Coach, Equipment Required, and Music Tracks.
b. For Resource=Article: Publisher, Publish Date, Word Count, Primary Author, and Secondary Author.

The AI Tag section may include algorithmically inferred commonalities between items and attributes of items. The AI tags may be inferred with machine learning and other forms of artificial intelligence to further defines the resource by detailing additional specific attributes of the resource, e.g, by comparing to all items to all other items.

The present techniques can be understood with reference to an example Input/Output Process:
a. User finishes a prescribed 3-mile morning run while wearing their fitness tracker.
b. The prescription engine receives data that run is complete, and sends a push notification prescribing a “Post Run Stretching Session”.
c. User opens app and receives a prescription of a “9 Minute Post Run Stretching Session” adaptive workout.

In this example:
a. The event is an external workout complete event. In some cases, events may be organized into a hierarchical taxonomy of events, and needs and prescriptions may be mapped to different levels of the hierarchy/entries in the taxonomy.
b. The User Needs met is Guidance.
c. The Influencing User Profile Data includes: Workout Type, Workout Intensity, Time Since Last Workout, Workout History, Primary Fitness Goal, and Current Fitness Level.
d. The Resources Prescribed responsive to the event, need and profile data is “9 Minute Post Run Stretching Session”
e. The Prescribed Resource Outcome Scored may then later be received, e.g., Burned 487 Calories.

FIG. 10 shows an example of a computing environment 920 with a prescription engine 922 that may cooperate with native applications on mobile user devices 924 and other components to effectuate some or all of the above-described techniques. In some embodiments, the computing environment 920 is a distributed computing environment, for example, having multiple distinct computing devices distributed over a relatively large geographic area, like the continental United States or the world. In some embodiments, the computing environment 920 includes the prescription engine 922, mobile user devices 924, wearable computing devices 926, third party application program interface servers 928, various Internet of things appliances 930, and a network 932, such as the Internet and various intermediary wireless networks or local area networks. Three of each item that may be present in multiple instances are shown by way of example, but commercial embodiments are expected to be substantially more complex, with tens of thousands or millions (or more) of user devices, hundreds (or more) of third party APIs, and tens of thousands or millions of Internet of things appliances. The prescription engine 922 may also be replicated (or subsets thereof), for instance in a microservices architecture or serverless architecture that elastically scales instances of the illustrated components responsive to need.

In some embodiments, the mobile user devices 924 may be computing devices having batteries like those described above, such as cell phones, tablet computers, and the like. In some embodiments, the mobile user devices form a personal area network with one or more wearable computing devices worn by a corresponding user, as indicated by elements 926. In some cases, these personal area networks are Bluetooth™ networks or near field communication networks, or in some cases the wearable devices 926 may connect directly to the Internet 932 via an independent wireless radio configured for such connections. In some embodiments, the wearable computing devices 926 may have corresponding applications executing on the mobile user device 924 by which functionality of the wearable computing devices 926 is exposed to other applications on the mobile user device 924, such as via a health or fitness related application program interface. In some embodiments, the mobile user devices 924 execute a native application of the prescription engine 922, such as an application like that described above by which videos are displayed, and that native application may communicate with the prescription engine 922 via an application program interface of the prescription engine 922, in some cases via the Internet 932.

The third-party application program interface servers 928 are, in some cases, any of the various types of servers described above by which events and data relating to those events may be obtained from third-party applications, such as airline or hotel reservation systems, fitness-facility member management systems, third-party application program interface servers that expose data gathered by Internet of things appliances 930 or by wearable computing devices 926, and the like. In some embodiments, the Internet of things appliances 930 are home-based Internet of things appliances, like the examples described above, such as smart lights, network-connected scales, smart thermostats, smart refrigerators, security systems configured to indicate whether the user is present, smart beds or pillows configured to indicate a user sleeping behavior, and the like. In some embodiments, the Internet of things appliances 930 are appliances in a fitness facility, such as networked gym equipment having actuators by which intensity or difficulty of the workout equipment may be modulated and sensors by which a user's use of the equipment may be monitored, including biometric sensors and sensors indicative of movement of the equipment, like tachometers, accelerometers, strain gages, and the like. In some embodiments, these Internet of things appliances 930 may also expose application program interfaces, either directly to the prescription engine 922 or via one of the third-party API servers 928, by which actuators of the Internet of things appliances may be adjusted, for instance, responsive to a command changing a set point, content may be sent for presentation on the appliance, and by which data gathered by sensors of the Internet of things appliances 930 may be interrogated.

In some embodiments, the prescription engine 922 may include an application program interface server 934, a controller 936, a need parameter repository 938, a prescription parameter repository 940, a user profile repository 941, an outcome log 942, a resource repository 944, a prescription templates repository 946, an event ingest module 948 (such as an event handler), a need assessment module 950, and a prescription module 952. (The term “module” is used interchangeably with the term “component” above a may refer to a subset of a program, a program, or a collection of programs that provide the described functionality).

In some embodiments, the application program interface server 934 is configured to interface with native applications of the prescription engine 922 executing on mobile user devices 924. In some cases, user inputs into various user interfaces may be conveyed to the prescription engine via the application program interface servers 934, following user entry of those inputs into a user interface of the native application. In some embodiments, the native application may further be configured to send application program interface requests indicative of events detected with a native application, either responsive to user interface inputs, or received via a background process of the native application, to the prescription engine via the application program interface server 934. Further, in some cases, the application program interface server 934 may be configured to send data, such as commands, to the mobile user devices, the wearable devices, the third-party API servers, or the Internet of things appliances 930 via the Internet 932 responsive to the operations of the prescription engine to effectuate the functionality described.

In some embodiments, the controller 936 may execute a process described below with reference to FIG. 11 and coordinate the operation of the other components of the prescription engine.

In some embodiments, the event ingest module 948 may receive events from the other components of the computing environment 920 passed through the API server 934. In some cases, these events may be push events, or in some cases, the events may be pulled events that are received by, for example, periodically or responsive to some input, querying one of the other components of the computing environment 920 by the prescription engine 922. Examples of events are described above. Such events, in some cases, may indicate a current or future state of a user, such as a change in the current or future state, of a user. In some cases, events are received in association with a user identifier, which in some cases may be associated with the user identifier unique to the user in a namespace of the prescription engine in a user profile, like those described above.

In some embodiments, the need parameter repository 938 may store parameters by which a next fitness-related the need of the user responsive to an event may be determined in accordance with the techniques described herein. In some embodiments, the parameters are a collection of rules (such as a sequential list of needs) by which a subsequent need is determined responsive to one or more previous prescriptions or outcomes of those prescriptions. Examples include a rule specifying that after a user is sent a prescription for a fitness-related activity involving an exercise, the user needs to be encouraged; and another rule specifying the after the user is encouraged, the user needs to be held to account; and another rule specifying that after the user indicates they have engaged in the fitness-related activity of the exercise, the user needs to be congratulated or presented with analytics indicative of their performance. Yet another rule may then specify that after the user is congratulated, the user needs to be presented with an interface by which the user may connect with other users in a social network who have engaged in similar activities. In some embodiments, needs may specify types of prescriptions, such as subsets of prescriptions that may be effectuated with the prescription engine 922, without fully specifying the prescription. In another embodiment, the need parameter repository 938 may include a plurality of parameters of a machine learning model by which needs are inferred given a current state of a user indicated by an event. Examples of such parameters include transition probabilities of a hidden Markov model and weights of a recurrent neural network, such as a long short-term memory neural network, or the like. In some embodiments, these parameters may be configured with the techniques described below with reference to FIG. 11 in a training routine.

In some embodiments, the prescription parameter repository 940 contains parameters by which a prescription is composed or otherwise formed, such as selected, given an identified need. Again, rule-based or machine learning approaches may be implemented. Some embodiments may include a collection of rules by which prescriptions are assigned. Rules may be mapped to needs and selected according to need. In some cases, subsets of the rules may be associated with different types of needs. In some embodiments, the rules may specify prescription templates by which prescriptions may be composed from resources in the resource repository 944. Examples of this approach are described above with some of the placeholders for calls to action and resources. In some cases, the prescription parameters are parameters of a machine learning model by which a prescription is formed given a need. Examples include weights in a deep neural network, splits in a decision or classification tree, or the like. Again, these parameters may be trained with the process described below with reference to FIG. 11 responsive to feedback indicative of outcomes of prescriptions.

Some embodiments may further include user profiles in a repository 941 having the user profiles described herein. Some embodiments may further include a user profile repository having attributes like those described above in reference to records of the user profile component 924. In some cases, the user profiles may include a goal of the user, such as a fitness goal, and a fitness history indicative of previous prescriptions and their outcome for a user.

Some embodiments may receive outcomes of prescribed fitness-related activities via the API server 934 and log those outcomes. In some embodiments, the outcome includes a record indicating whether the user accessed a prescription, indicating whether a user accessed resources identified in the prescription, indicating whether a user completed viewing those resources where the resources are media, indicating biometric measurements or activity measurements from wearable devices 926, indicating access to Internet of things appliances 930 or sensor readings indicating levels of effort or intensity, indicating whether the user checked into a gym and how long they were there or other fitness related facility, and self reported outcomes, like ratings from 1 to 10 or binary values indicating whether the user engaged in the activity reported through a native application on mobile user devices in association with the prescription. In some cases, these records may be logged in association with the prescriptions and timestamps of the prescriptions and the reported outcomes. The logged results may then be accessed later for training and adjustment of the parameters and repositories 938 and 940.

Some embodiments may further include a resource repository 944 storing the above-described fitness-related resource records. As noted, fitness-related resources may be organized into tangible and intangible fitness-related resources. And those fitness-related resources may be associated with various attributes, for instance scored and non-scored attributes of the resources, for instance, arranged in an ontology of resources in the resource repository, in some cases with a hierarchical taxonomy of resources for certain attributes.

In some embodiments, the prescription engine 922 may further include prescription templates repository 946, which may include a plurality of partially-composed prescriptions, in some cases mapped to different types of needs or different types of prescriptions in the repositories 938 or 940. In some embodiments, the prescription templates may include variables that identify types of resources and types of calls to actions, in some cases with multiple types of resources identified and a relationship between those different types specified by the prescription template. In some embodiments, the prescription templates may further include variables by which different types of relationships between resources, calls to action, and other inputs may be specified. Thus, in some cases, the templates may be characterized as a domain specific programming language.

In some embodiments, the event ingest module 948 may be operative to receive events passed through the API server 934 and form an event record by which subsequent activities may be initiated and effectuated. In some embodiments, the event ingest module 948 is configured to receive an event with a user identifier in a different user identifier namespace from that of the prescription engine 922 and associate that user identifier with a user identifier in the namespace of the prescription engine, that user identifier uniquely identifying a user among other users of the prescription engine 922. In some embodiments, user profiles may store user identifiers of users in different applications related to the different third-party API servers, different wearable devices, different applications on the mobile user devices, or different Internet of things appliances 930, and the event ingest module 948 may access user profiles to correlate between these different user identifiers. Further, in some embodiments, event ingest module 948 may classify an event into various categories, such as indicating that a previous prescribed activity has been completed, a prescribed activity has begun, a user's geolocation has changed (e.g., by more than a threshold amount, or across a geofence), a user's future geolocation has changed, an environmental condition, like the weather has changed, an amount of time in some state has elapsed, or the like. In some cases, different needs may be inferred or otherwise selected responsive to these categorizations.

In some embodiments, the need-assessment module 950 may receive events and determine a fitness-related need responsive to the event. In some cases, this may include accessing the above-described rules in the need-parameter repository and applying those rules to the event and other historical data of a user in the user profile, and in some cases to environmental data, like weather, geolocation of the user, and the like. In some cases, the need assessment module 950 may output a type of need by applying the rules to this data, or in some cases the need-assessment module 950 may output a type of need by inputting these values into a machine learning model using the above-described need parameters in such models. In some embodiments, the need is determined, in part, based on a user's goals, such as fitness goals in the user profile and a history of previous prescriptions and their outcomes, for instance, in accordance with the examples described above.

Next, the prescription module 952 may be configured to receive a type of need based on the event. In some embodiments, the prescription module 952 is configured to apply rules in the prescription parameter repository 940 to the event and various environmental and other factors in the user profile to output a prescribed fitness-related activity. In some cases, this may include inputting these values into a machine-learning model having parameters like those described above to output a prescription or selection of a prescription template. In some cases, either responsive to rules or machine learning models, the prescription module 952 may select among prescription templates and then using another set of rules or a corresponding downstream machine learning model, variables in the prescription template may be populated with entries selected from the resource repository 944. In some embodiments, resources may be selected based on a fitness history of the user, goals of the user, the event, a geolocation of the user, environmental parameters of the user, and the like to populate the prescription template that is selected. In some embodiments, the prescription module 952 then returns the formed current fitness-related prescription to the controller 936, which may then instruct the API server 934 to cause that prescription to be presented to the user.

As noted above, causing prescriptions to be presented to the user may include causing the native application on mobile user devices 924 to present a notification or configure a user interface that describes the prescription. Or prescriptions may be caused to be presented on wearable computing devices 926, or adjustments may be made to set points or user interfaces of Internet of things appliances 930. In some embodiments, records of third-party API servers 928 may be updated to effectuate the prescription, for example, registering a reservation for the user in some fitness-related activity.

In some embodiments, the controller 936 of FIG. 10 may execute a process 954 shown in FIG. 11, though embodiments are not limited to that implementation, which is not to suggest that any other description is limiting. In some embodiments, multiple instances of the process 954 may be executed concurrently in service of different sessions with different user computing devices. Further, in some cases, different subsets of the process 954 may be executed concurrently relative to other subsets of the process 954. Further, in some cases steps may be omitted, additional steps may be added, the steps may be executed serially, or the steps may be executed concurrently, none of which is to suggest that any other feature described herein is limiting.

In some embodiments, the process 954 includes monitoring a network socket for events, as indicated by block 956. In some embodiments, this may include monitoring a network socket via the application program interface server 934, such as a collection of network sockets associated with different types of events from different portions of the computing environment 920 described above. In some embodiments, monitoring may include detecting receipt of a response to a previously sent request for new events in a pull request, or monitoring may include receiving events in push communications. In some embodiments, events may be communicated as hypertext transport protocol requests. Events, in some cases, may be sent via web socket communications.

Some embodiments may determine whether an event has been received, as indicate by block 958. Upon determining that an event has not been received, some embodiments may return to block 956 and continue monitoring. Alternatively, upon determining that an event has been received, some embodiments may proceed to block 960. Some embodiments may implement a non-blocking server by which events are processed asynchronously, for example with promises or deferreds, while the non-blocking server continues to ingest additional events, without preventing the processing of one event from interfering with the receipt of a subsequent event. In some cases, events may be received at a relatively high rate, for instance, with more than 100 events per hour, and in some cases with more than 100 or more than 1000 events per minute for relatively large user bases and rich event sets.

Some embodiments may receive an event indicative of a current or future state of a user, as indicated by block 960, for instance, with the above-described event ingest module 948 at the direction of controller 936.

Some embodiments may then access a user profile corresponding to the event, as indicated by block 962, and determine previous fitness-related activities of that user based on the profile, as indicated by block 964. Previous fitness activities may include both previously prescribed exercises, as well as other prescribed activities that affect fitness, such as the previous night's sleep duration and quality, hydration, nutrition, scheduling of exercises, and the like, among other examples discussed herein. The previous fitness activity may also include non-prescribed activities, such as self-reported (un-prescribed) exercises (like a walk or taking the stairs at work), and data queried from the above-noted APIs (like fitness tracker readings, measurements from smart scales, other bio-metric measurements, or meal-logging entries).”

Also based on the profile in some cases, some embodiments may determine a fitness goal of the user, as indicated by block 966. Some embodiments may then access need-parameters, such as rules or machine learning parameters like those described above and the need parameter repository 968 and determine a fitness need of the user, as indicated by block 970. Goals may map to needs in various forms, including indicating that a need exists at all, or indicating that additional encouragement or accountability is needed due to a delta between a goal and a current state of the user.

Some embodiments may then access prescription parameters, as indicated by block 972, such as the rules or machine learning parameters in the prescription parameter repository 940 described above. In some cases, a prescription template may be identified based on the need, and in some cases, some of the prescription parameters. Some embodiments may then access a prescription template or templates, as indicated by block 974. As noted, prescription templates, in some cases, may include variables, such as value specifying queries by which fitness resources corresponding to various query criteria may be selected from the resource repository 944. Some embodiments may apply those queries to the resource repository to access fitness-related resources, as indicated by block 976. Some embodiments may then determine a current fitness-related prescription, as indicated by block 978, for example based on the need, the events, the user's profile, the template, and the responsive fitness resources. In some cases, this may include applying some of the described rules or machine learning parameters, for instance, in a secondary machine learning model, in the prescription parameter repository 940 to populate the prescription template with the candidate fitness resources responsive to the query. Some embodiments, in some cases, may select randomly among candidate fitness resources responsive to the queries, or some embodiments may select by calculating a candidate fitness-related resource score for each candidate. Scores, in some cases, may be based upon an amount of attributes of the fitness-related resource that satisfy criteria of a determined need, the user's goals, intensity thresholds, proficiency thresholds, user-specified preferences for types of workouts, or the like.

Next, embodiments may cause the current fitness-related prescription to be presented to the user, as indicated by 980. As noted, this may include sending instructions to a native application on the user's mobile computing device, sending instructions to a third-party API server, sending instructions to Internet of things appliances, or sending instructions to a wearable computing device.

Some embodiments may learn from feedback and adjust the parameters by which needs are determined or prescriptions are formed. To this end, some embodiments may obtain and log feedback, as indicated by block 982. Some embodiments may periodically, for instance weekly, monthly, or yearly, or more or less often, determine whether a time has arrived to train a machine learning model responsive to the feedback, as indicated by block 984. Upon determining that it is not time to train the model, some embodiments may return to block 956 and continue to monitor the network socket for new events.

Alternatively, for instance concurrently in a batch process, some embodiments may determine that it is time to train the model. In some embodiments, a rules-based approach may be applied while a training set is acquired, for instance over a six-month or one-year period, and then the resulting training set may be input into the algorithms described below to train a machine learning model. Some embodiments may proceed to modify need parameters based on the feedback, as indicated by block 986. Some embodiments may further modify prescription parameters based on the feedback, as indicated by block 988. In some cases, the modification may include adjusting scores by which rules are ranked, or adjusting scores by which resources are ranked for selection. In some cases, training may include training any of the above-describe machine learning models.

In some embodiments, training may include optimizing or otherwise improving, for instance maximizing or minimizing, an objective function (like a cost function, error function, or fitness function) of each of the respective machine learning models. In some cases, the objective function is a score indicative of an amount of users having various attributes (like goals, age, fitness history, weight, height, or impairments) in the user profile that obtain outcomes, like view, start, complete, or achieve a threshold level of performance in prescribed fitness-related activities. In some embodiments, the objective function is a weighted combination of these different types of outcomes.

To begin training, some embodiments may initialize the machine learning model parameters, for instance, to random values, and then repeatedly until a termination condition is reached, calculate partial derivatives of the objective function with respect to each of the model parameters and then adjust the model parameters by a predetermined increment in a direction that the respective partial derivative indicates tends to optimize locally the objective function. Examples of a termination condition include a threshold amount of iterations or detecting that there is less than a threshold amount of change between consecutive iterations in the objective function.

In another example, some embodiments may sequentially iterate through each dimension of an input parameter space of the machine learning model and determine a split in a parameter space of the model that optimizes the objective function in that respective dimension, for instance with a greedy optimization algorithm to train a decision or classification tree.

In some embodiments, the training operation may be repeated multiple times with different randomly-selected initial parameter settings, and a repetition that produces a result with the objective function that is better than the other repetitions may be selected. In some embodiments, a subset of training data may be withheld from training and the resulting trained model may be scored with cross validation by testing the model against the withheld training data and determining whether a measure of performance of the objective function with the withheld data after training satisfies a threshold.

In some embodiments, the machine learning model is trained based on a model of the user's behavior, such as a model that predicts the user's behavior responsive to various input conditions. Some embodiments may first train a user model that predicts the various types of outcomes above given an input of the various types of prescriptions for a given or specified set of user profile attributes. Some embodiments may then train a prescription or need determining machine learning model with this user model with reinforcement learning, for instance, by repeatedly simulating making prescriptions that are input into the user model, predicting how a user (at a given point in a space of user attributes) would respond to that prescription with the user model, and then adjusting the prescription or need model responsive to the prediction of the user model. As a result, the prescription or need models may undergo tens or hundreds of millions of attempted prescriptions in simulated use cases and be trained, for instance, with the techniques described above, based on simulated log results that log the predicted outcome from the user model given the attempted prediction.

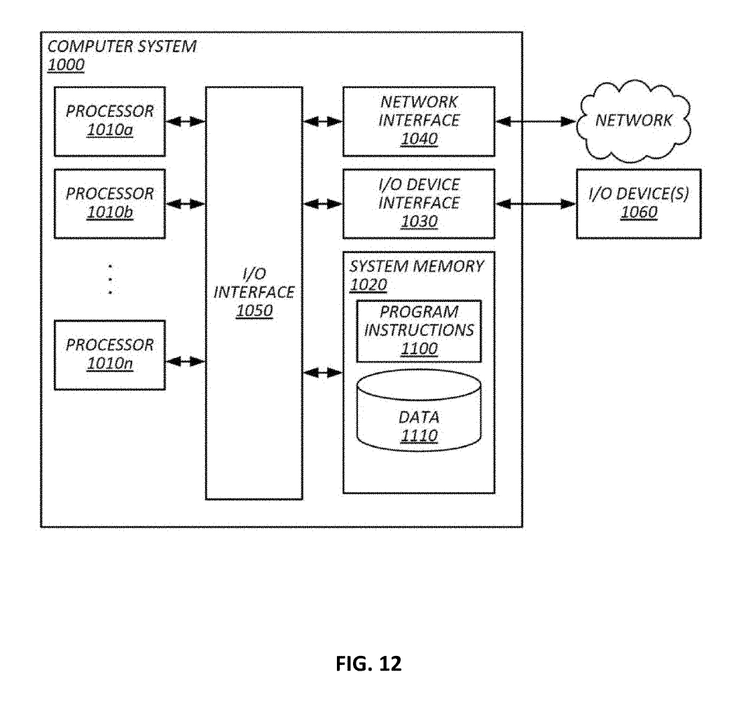

FIG. 12 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The present techniques will be better understood with reference to the following enumerated embodiments:

1. A tangible, non-transitory, machine-readable medium storing instructions that when executed by one or more processors effectuate operations to prescribe fitness-related activities responsive to events, the operations comprising: receiving, with one or more processors, with a fitness prescription engine, an event indicative of a current or future state of a user, wherein: the user is associated with a mobile computing device upon which a native application executes; the native application is configured to send events to the fitness prescription engine via a network; and the fitness prescription engine is configured to prescribe fitness-related activities responsive to events for a user-base with a plurality of users including the user; determining, with one or more processors, with the fitness prescription engine, a fitness need of the user based on a user profile of the user, wherein: the fitness need is determined based on a fitness goal of the user in the user profile; and the fitness need is determined based on a previous fitness-related prescription in the user profile; determining, with one or more processors, with the fitness prescription engine, a current fitness-related prescription in response to both the fitness need and the event, wherein: determining the current fitness-related prescription comprises selecting a fitness resource from among a plurality of candidate fitness resources; and the selected fitness resource is designated in the current prescription as a fitness resource to be accessed by the user in accordance with the current prescription; and causing, with one or more processors, with the fitness prescription engine, the current fitness-related prescription to be presented to the user.
2. The medium of embodiment 1, wherein: the event is an external event received from a third-party application program interface; the event is one of two received events for which prescriptions are provided by the fitness prescription engine, the two received events including a first event generated by a fitness-center-membership management system indicating the user is checked in at a fitness center and a second event generated by network-connected workout equipment in use by the user indicating use of the network-connected workout equipment by the user; and at least one of the two events is received without being relayed by the mobile computing device.
3. The medium of any one of embodiments 1-2, wherein: the event is one of three or more received events for which prescriptions are provided by the fitness prescription engine among the following: an event generated by an airline-reservation system indicating that the user has booked or checked into a flight; an event generated by a hotel-reservation system indicating that the user has reserved or checked into a hotel room; an event generated by a wedding or baby registry management system; an event indicative of weather; an event indicative of a calendar entry of the user; an event generated by a meal-logging application; an event indicative of the user signing up for or attending an athletic activity; or an event indicative of the user's geolocation.
4. The medium of any one of embodiments 1-3, wherein: the event is one of three or more events for which prescriptions are provided by the fitness prescription engine among the following: an event indicative of the user waking up or going to bed; an event indicative of the user's heart rate or change thereof; an event indicative of the user's blood-oxygen level or change thereof; an event indicative of the user's physical activity or change thereof; an event indicative of the user's hydration state or change thereof; and an event indicative of the user completing or starting a previously prescribed fitness activity; or at least some of the three or more events are generated responsive to measurements by a wearable computing device of the user.
5. The medium of any one of embodiments 1-4, wherein: the event is one of a plurality of events for which prescriptions are provided by the fitness prescription engine including all of the following: an event generated by a fitness-center-membership management system indicating the user is at a fitness center; an event generated by network-connected workout equipment in use by the user; an event generated by an airline-reservation system indicating that the user has booked or checked into a flight; an event generated by a hotel-reservation system indicating that the user has reserved or checked into a hotel room; an event generated by a wedding or baby registry management system; an event indicative of weather; an event indicative of a calendar entry of the user; an event generated by a meal-logging application; an event indicative of the user signing up for or attending an athletic event; an event indicative of the user's geolocation; an event indicative of the user waking up or going to bed; an event indicative of the user's heart rate or change thereof; an event indicative of the user's blood-oxygen level or change thereof; an event indicative of the user's physical activity or change thereof; an event indicative of the user's hydration state or change thereof; and an event indicative of the user completing or starting a previously prescribed fitness activity.
6. The medium of any one of embodiments 1-5, wherein: more than 1,000 events are received per hour; prescriptions responsive to events are provided within five minutes of respective events to which respective prescriptions are responsive; more than 10,000 users are in the userbase; and the plurality of candidate resources comprises more than 2,000 candidate fitness resources.
7. The medium of any one of embodiments 1-6, wherein: determining the fitness need comprises: accessing a sequence of types of prescriptions, the types including at least three of the following: user guidance; user motivation; user affirmation; post-activity celebration; user education; user accountability; connections between users; user entertainment; fitness equipment; and professional fitness assistance; determining a current state of the user in the sequence after a previously prescription in the sequence; and determining a category of a subsequent prescription from the sequence based on the current state of the user in the sequence.
8. The medium of any one of embodiments 1-7, wherein: determining the fitness need comprises inputting the previous fitness-related prescription or result thereof into a hidden Markov model or recurrent neural network trained to infer sequences of fitness related needs.
9. The medium of any one of embodiments 1-8, wherein: determining the current fitness-related prescription comprises: determining which of a plurality of prescription-selection rules apply based on the previous fitness-related prescription; and selecting a prescription-template based on applicable prescription-selection rules; and populating the prescription-template with the fitness resource based on the user profile to at least partially form the current fitness-related prescription.
10. The medium of embodiment 9, wherein: the selected fitness-template specifies an intangible resource and a tangible resource are to be combined in the current fitness-related prescription; and the intangible resource is selected based on an intensity associated with the intangible resource and the user profile; and the tangible resource is selected without regard to the intensity associated with the intangible resource.
11. The medium of any one of embodiments 1-10, wherein: the current fitness-related prescription is determined based on feedback from previous fitness-related prescriptions.
12. The medium of any one of embodiments 1-11, wherein: the current fitness-related prescription is determined based on a machine learning model trained on logged outcomes of previous fitness-related prescriptions.
13. The medium of embodiment 12, wherein the operations comprise: obtaining a training data set, the training data set comprising logged records of previous fitness-related prescriptions and outcomes of the previous fitness-related prescriptions, the outcomes including an indication of whether corresponding users acted on the previous fitness-related prescriptions; and configuring parameters of the machine learning model by adjusting the parameters to at least partially optimize an objective function based, at least in part, on the outcomes.
14. The medium of embodiment 13, wherein: optimizing comprises determining a plurality of partial derivatives of the objective function with respect to the respective parameters of the machine learning model; and adjusting the parameters by respective increments in directions that the partial derivatives indicate tend to optimize the objective function.
15. The medium of any one of embodiments 1-14, wherein: the plurality of candidate fitness resources include both more than 20 tangible candidate fitness resources and more than 20 intangible candidate fitness resources; and the fitness prescription engine comprises an ontology of the candidate fitness resources, the ontology comprising at least four of the following for each of at least some of the candidate fitness-related resources:
a definition; one or more categorization indicators; a purpose indicator; a focus composition indicator; an intensity indicator; a fitness discipline; a proficiency indicator; at least some non-scored attributes; or one or more machine-generated attributes inferred from logged historical records of the fitness prescription engine.
16. The medium of embodiment 15, wherein: the ontology comprises each of the following for each of at least some of the candidate fitness-related resources: a definition; one or more categorizations; a purpose; focus composition scores; an intensity score; a fitness discipline score; a proficiency score; at least some non-scored attributes; and one or more machine-generated attributes inferred from logged historical records of the fitness prescription engine.
17. The medium of any one of embodiments 1-16, wherein: causing the current fitness-related prescription to be presented to the user comprises sending instructions to the native application to present the current fitness-related prescription on the mobile computing device; and the current fitness-related prescription comprises a call to action with a navigable link to a computer-accessible resource by which the user pursues the call to action.
18. The medium of any one of embodiments 1-17, wherein: causing the current fitness-related prescription to be presented to the user comprises sending instructions that cause a wearable fitness tracker of the user to present the current fitness-related prescription.
19. The medium of any one of embodiments 1-18, wherein: causing the current fitness-related prescription to be presented to the user comprises sending instructions that cause an Internet-of-things (IoT) appliance to adjust a state of the appliance.
20. The medium of embodiment 19, wherein: the IoT appliance is networked workout equipment and the state is an intensity or difficulty setting of the networked workout equipment.
21. A system comprising: one or more computer processors; and storage media, storing machine-readable instructions that, when executed by at least some of the one or more processors, cause operations comprising: the operations of any of embodiments 1-20.
22. A method, comprising: the operations of any of embodiments 1-20.

What is claimed is:

1. A tangible, non-transitory, machine-readable medium storing instructions that when executed by one or more processors effectuate operations to prescribe fitness-related activities responsive to events, the operations comprising:
receiving, with one or more processors, with a fitness prescription engine, an event indicative of a current or future state of a user, wherein:
the user is associated with a mobile computing device upon which a native application executes;
the native application is configured to send events to the fitness prescription engine via a network; and
the fitness prescription engine is configured to prescribe fitness-related activities responsive to events for a user-base with a plurality of users including the user;
determining, with one or more processors, with the fitness prescription engine, a fitness need of the user based on a user profile of the user, wherein:
the fitness need is determined based on a fitness goal of the user in the user profile; and
the fitness need is determined based on a previous fitness-related prescription in the user profile;
determining, with one or more processors, with the fitness prescription engine, a current fitness-related prescription in response to both the fitness need and the event, wherein:
determining the current fitness-related prescription comprises selecting a fitness resource from among a plurality of candidate fitness resources; and
the selected fitness resource is designated in the current prescription as a fitness resource to be accessed by the user in accordance with the current prescription; and
causing, with one or more processors, with the fitness prescription engine, the current fitness-related prescription to be presented to the user.

2. The medium of claim 1, wherein:
the event is an external event received from a third-party application program interface;
the event is one of two received events for which prescriptions are provided by the fitness prescription engine, the two received events including a first event generated by a fitness-center-membership management system indicating the user is checked in at a fitness center and a second event generated by network-connected workout equipment in use by the user indicating use of the network-connected workout equipment by the user; and
at least one of the two events is received without being relayed by the mobile computing device.

3. The medium of claim 1, wherein:
the event is one of three or more received events for which prescriptions are provided by the fitness prescription engine among the following:
an event generated by an airline-reservation system indicating that the user has booked or checked into a flight;
an event generated by a hotel-reservation system indicating that the user has reserved or checked into a hotel room;
an event generated by a wedding or baby registry management system;
an event indicative of weather;
an event indicative of a calendar entry of the user;
an event generated by a meal-logging application
an event indicative of the user signing up for or attending an athletic activity; or
an event indicative of the user's geolocation.

4. The medium of claim 1, wherein:
the event is one of three or more events for which prescriptions are provided by the fitness prescription engine among the following:
an event indicative of the user waking up or going to bed;
an event indicative of the user's heart rate or change thereof;
an event indicative of the user's blood-oxygen level or change thereof;
an event indicative of the user's physical activity or change thereof;
an event indicative of the user's hydration state or change thereof; and
an event indicative of the user completing or starting a previously prescribed fitness activity; or
at least some of the three or more events are generated responsive to measurements by a wearable computing device of the user.

5. The medium of claim 1, wherein:
the event is one of a plurality of events for which prescriptions are provided by the fitness prescription engine including all of the following:
an event generated by a fitness-center-membership management system indicating the user is at a fitness center;
an event generated by network-connected workout equipment in use by the user;
an event generated by an airline-reservation system indicating that the user has booked or checked into a flight;
an event generated by a hotel-reservation system indicating that the user has reserved or checked into a hotel room;
an event generated by a wedding or baby registry management system;
an event indicative of weather;
an event indicative of a calendar entry of the user;
an event generated by a meal-logging application
an event indicative of the user signing up for or attending an athletic event;
an event indicative of the user's geolocation;
an event indicative of the user waking up or going to bed;
an event indicative of the user's heart rate or change thereof;
an event indicative of the user's blood-oxygen level or change thereof;
an event indicative of the user's physical activity or change thereof;
an event indicative of the user's hydration state or change thereof; and
an event indicative of the user completing or starting a previously prescribed fitness activity.

6. The medium of claim 1, wherein:
more than 1,000 events are received per hour;
prescriptions responsive to events are provided within five minutes of respective events to which respective prescriptions are responsive;
more than 10,000 users are in the userbase; and
the plurality of candidate resources comprises more than 2,000 candidate fitness resources.

7. The medium of claim 1, wherein:
determining the fitness need comprises:
accessing a sequence of types of prescriptions, the types including at least three of the following:
user guidance;
user motivation;
user affirmation;
post-activity celebration;
user education;
user accountability;
connections between users;
user entertainment;
fitness equipment; and
professional fitness assistance;
determining a current state of the user in the sequence after a previously prescription in the sequence; and
determining a category of a subsequent prescription from the sequence based on the current state of the user in the sequence.

8. The medium of claim 1, wherein:
determining the fitness need comprises inputting the previous fitness-related prescription or result thereof into a hidden Markov model or recurrent neural network trained to infer sequences of fitness related needs.

9. The medium of claim 1, wherein:
determining the current fitness-related prescription comprises:
determining which of a plurality of prescription-selection rules apply based on the previous fitness-related prescription; and
selecting a prescription-template based on applicable prescription-selection rules; and
populating the prescription-template with the fitness resource based on the user profile to at least partially form the current fitness-related prescription.

10. The medium of claim 9, wherein:
the selected fitness-template specifies an intangible resource and a tangible resource are to be combined in the current fitness-related prescription; and
the intangible resource is selected based on an intensity associated with the intangible resource and the user profile; and
the tangible resource is selected without regard to the intensity associated with the intangible resource.

11. The medium of claim 1, wherein:
the current fitness-related prescription is determined based on feedback from previous fitness-related prescriptions.

12. The medium of claim 1, wherein:
the current fitness-related prescription is determined based on a machine learning model trained on logged outcomes of previous fitness-related prescriptions.

13. The medium of claim 12, wherein the operations comprise:
obtaining a training data set, the training data set comprising logged records of previous fitness-related prescriptions and outcomes of the previous fitness-related prescriptions, the outcomes including an indication of whether corresponding users acted on the previous fitness-related prescriptions; and
configuring parameters of the machine learning model by adjusting the parameters to at least partially optimize an objective function based, at least in part, on the outcomes.

14. The medium of claim 13, wherein:
optimizing comprises determining a plurality of partial derivatives of the objective function with respect to the respective parameters of the machine learning model; and
adjusting the parameters by respective increments in directions that the partial derivatives indicate tend to optimize the objective function.

15. The medium of claim 1, wherein:
the plurality of candidate fitness resources include both more than 20 tangible candidate fitness resources and more than 20 intangible candidate fitness resources; and
the fitness prescription engine comprises an ontology of the candidate fitness resources, the ontology comprising at least four of the following for each of at least some of the candidate fitness-related resources:
a definition;
one or more categorization indicators;
a purpose indicator;
a focus composition indicator;
an intensity indicator;
a fitness discipline;
a proficiency indicator;
at least some non-scored attributes; or
one or more machine-generated attributes inferred from logged historical records of the fitness prescription engine.

16. The medium of claim 15, wherein:
the ontology comprises each of the following for each of at least some of the candidate fitness-related resources:
a definition;
one or more categorizations;
a purpose;
focus composition scores;
an intensity score;
a fitness discipline score;
a proficiency score;
at least some non-scored attributes; and
one or more machine-generated attributes inferred from logged historical records of the fitness prescription engine.

17. The medium of claim 1, wherein:
causing the current fitness-related prescription to be presented to the user comprises sending instructions to the native application to present the current fitness-related prescription on the mobile computing device; and
the current fitness-related prescription comprises a call to action with a navigable link to a computer-accessible resource by which the user pursues the call to action.

18. The medium of claim 1, wherein:
causing the current fitness-related prescription to be presented to the user comprises sending instructions that cause a wearable fitness tracker of the user to present the current fitness-related prescription.

19. The medium of claim 1, wherein:
causing the current fitness-related prescription to be presented to the user comprises sending instructions that cause an Internet-of-things (IoT) appliance to adjust a state of the appliance.

20. The medium of claim 19, wherein:
the IoT appliance is networked workout equipment and the state is an intensity or difficulty setting of the networked workout equipment.

21. A method, comprising:
receiving, with one or more processors, with a fitness prescription engine, an event indicative of a current or future state of a user, wherein:
the user is associated with a mobile computing device upon which a native application executes;
the native application is configured to send events to the fitness prescription engine via a network; and
the fitness prescription engine is configured to prescribe fitness-related activities responsive to events for a user-base with a plurality of users including the user;
determining, with one or more processors, with the fitness prescription engine, a fitness need of the user based on a user profile of the user, wherein:
the fitness need is determined based on a fitness goal of the user in the user profile; and
the fitness need is determined based on a previous fitness-related prescription in the user profile;
determining, with one or more processors, with the fitness prescription engine, a current fitness-related prescription in response to both the fitness need and the event, wherein:
determining the current fitness-related prescription comprises selecting a fitness resource from among a plurality of candidate fitness resources; and
the selected fitness resource is designated in the current prescription as a fitness resource to be accessed by the user in accordance with the current prescription; and
causing, with one or more processors, with the fitness prescription engine, the current fitness-related prescription to be presented to the user.

22. The method of claim 21, comprising:
providing the user access to a fitness facility.
